(19) United States
(12) Patent Application Publication
(10) Pub. No.: US 2026/0239180 A1
(43) Pub. Date: Aug. 13, 2026

(54) TERMINAL DEVICE AND COMMUNICATION METHOD

(71) Applicant: SONY GROUP CORPORATION, TOKYO (JP)

(72) Inventors: YOSHIO KONNO, TOKYO (JP); NAOYUKI TOYODA, TOKYO (JP); TAKUMA TAKADA, TOKYO (JP)

(21) Appl. No.: 19/153,559

(22) PCT Filed: Jan. 25, 2024
(86) PCT No.: PCT/JP2024/002147

§ 371 Date: Aug. 4, 2025

(30) Foreign Application Priority Data
Feb. 10, 2023 (JP) 2023-019357

(51) Int. Cl. H04W 48/16; H04W 48/20

(52) U.S. Cl. CPC H04W 48/16; H04W 48/20

(57) ABSTRACT

A terminal device is a terminal device functioning as a mobile station that performs wireless communication with at least one of one or more non-ground stations, the terminal device including: an acquisition unit that acquires weather information; and a determination unit that makes a determination related to the wireless communication on the basis of the weather information.

### FIELD

The present disclosure relates to a terminal device and a communication method.

### BACKGROUND

In recent years, with increasing demands for communication performance such as wide area coverage, studies on a non-terrestrial network (NTN) in which a wireless network is provided from a device floating in the air or space have started.

### CITATION LIST

### Patent Literature

Patent Literature 1: JP 2012-65138 A

Patent Literature 2: JP 2020-533897 A

### SUMMARY

### Technical Problem

In a non-terrestrial network, a propagation distance between a base station and a terminal device is longer than that in a terrestrial network. Therefore, in a case where the conventional communication technology is directly applied to a non-terrestrial network, high communication performance (for example, connection stability, low delay, high reliability, high throughput, power saving, low processing load, or the like) may not be realized.

Therefore, the present disclosure proposes a terminal device and a communication method capable of achieving high communication performance.

Note that the above problem or object is merely one of a plurality of problems or objects that can be solved or achieved by the plurality of embodiments disclosed in the present specification.

### Solution to Problem

In order to solve the above problem, a terminal device according to one embodiment of the present disclosure that functioning as a mobile station that performs wireless communication with at least one of one or more non-ground stations, the terminal device comprising: an acquisition unit that acquires weather information; and a determination unit that makes a determination related to the wireless communication on a basis of the weather information.

### BRIEF DESCRIPTION OF DRAWINGS

FIG. 1 is a diagram illustrating an outline of the present embodiment.

FIG. 2 is a diagram illustrating a configuration example of a communication system according to an embodiment of the present disclosure.

FIG. 3 is a diagram illustrating an example of a wireless network provided by a communication system 1.

FIG. 4 is a diagram illustrating an outline of satellite communication provided by the communication system 1.

FIG. 5 is a diagram illustrating an example of a cell configured by a non-geostationary satellite.

FIG. 6 is a diagram illustrating a configuration example of a management device according to an embodiment of the present disclosure.

FIG. 7 is a diagram illustrating a configuration example of a ground station according to an embodiment of the present disclosure.

FIG. 8 is a diagram illustrating a configuration example of a non-ground station according to an embodiment of the present disclosure.

FIG. 9 is a diagram illustrating a configuration example of a relay station according to an embodiment of the present disclosure.

FIG. 10 is a diagram illustrating a configuration example of a terminal device according to an embodiment of the present disclosure.

FIG. 11 is a diagram for describing an outline of a first solution.

FIG. 12 is a diagram for describing an outline of a second solution.

FIG. 13 is a diagram illustrating a sequence example of communication processing according to a first embodiment.

FIG. 14 is a diagram illustrating a sequence example of communication processing according to a second embodiment.

FIG. 15 is a diagram illustrating a sequence example of communication processing according to a third embodiment.

FIG. 16 is a diagram illustrating a sequence example of communication processing according to the third embodiment.

FIG. 17 is a diagram for describing a modification of a determination related to wireless communication.

FIG. 18 is a diagram for describing the modification of the determination related to wireless communication.

FIG. 19 is a diagram for describing the modification of the determination related to wireless communication.

FIG. 20 is a diagram for describing the modification of the determination related to wireless communication.

FIG. 21 is a diagram for describing the modification of the determination related to wireless communication.

FIG. 22 is a diagram for describing the modification of the determination related to wireless communication.

### DESCRIPTION OF EMBODIMENTS

Hereinafter, embodiments of the present disclosure will be described in detail with reference to the drawings. Note that, in the following embodiments, the same parts are denoted by the same reference signs, and redundant description will be omitted.

In addition, in the present specification and the drawings, a plurality of components having substantially the same functional configuration may be distinguished by attaching different numerals after the same reference signs. For example, a plurality of configurations having substantially the same functional configuration is distinguished as terminal devices 501, 502, and 503 as necessary. However, in a case where it is not particularly necessary to distinguish each of a plurality of components having substantially the same functional configuration, only the same reference sign is attached. For example, in a case where it is not necessary to particularly distinguish the terminal devices 501, 502, and 503, they are simply referred to as terminal devices 50.

One or more embodiments (including examples and modifications) described below can each be implemented independently. On the other hand, at least some of the plurality of embodiments described below may be implemented by being appropriately combined with at least some of other embodiments. The plurality of embodiments may include novel features different from each other. Therefore, the plurality of embodiments can contribute to solving different objects or problems, and can exhibit different effects.

### 1. Outline

Radio access technology (RAT) such as long term evolution (LTE) and new radio (NR) has been studied in 3GPP (registered trademark). LTE and NR are a type of cellular communication technology, and enable mobile communication of a terminal device by arranging a plurality of areas covered by a base station in a cell shape. In recent years, studies on 6G have also been started. The 6G is also a type of cellular communication technology, and enables mobile communication of the terminal device by arranging the plurality of areas covered by the base station in a cell shape. Note that a single base station may manage a plurality of cells.

Note that, in the following description, it is assumed that the “LTE” includes LTE-advanced (LTE-A), LTE-advanced pro (LTE-A Pro), and evolved universal terrestrial radio access (EUTRA). In addition, it is assumed that the NR includes new radio access technology (NRAT) and further EUTRA (FEUTRA). Note that a single base station may manage a plurality of cells. In the following description, a cell corresponding to the LTE is referred to as an LTE cell, and a cell corresponding to the NR is referred to as an NR cell.

The NR is a next-generation radio access system for the LTE, and is a radio access technology (RAT) different from the LTE. The NR is a radio access technology that can cope with various use cases including enhanced mobile broadband (eMBB), massive machine type communications (mMTC), and ultra-reliable and low latency communications (URLLC). The NR can implement a technical framework corresponding to usage scenarios, requirement conditions, arrangement scenarios, and the like in these use cases.

In addition, the 6G is a cellular communication technology of a next generation of the NR or 5G system (5GS) which is the fifth generation mobile communication.

The 6G includes a radio access technology and a network technology between a base station, a core network, and a data network. In the 6G, eMBB, mMTC, and URLLC, which are main use cases or required conditions in the NR, are enhanced. The technology provided in the 6G can include a technology related to AI (for example, cognitive network, AI native air interface), a technology related to sensing (for example, rader sensing, network as a sensor), and a technology related to terahertz communication.

### 1-1. Problem

With increasing demands for wide area coverage and the like, studies on a non-terrestrial network (NTN) have been started. For example, in recent years, a wireless network is scheduled to be provided to a terminal device via a base station or a relay station other than a ground station, such as a satellite station or an aircraft station. The base station other than the ground station is referred to as a non-ground station or a non-ground base station. In addition, the relay station other than the ground station is referred to as a non-ground station or a non-ground relay station. Note that the wireless network provided by the ground station is referred to as a terrestrial network (TN). By using the terrestrial network and a non-terrestrial network as the same radio access system, integrated operation of the terrestrial network and the non-terrestrial network becomes possible.

In the non-terrestrial network, the propagation distance between the base station or the relay station and the terminal device is longer than that in the terrestrial network. For example, in the non-terrestrial network, the base station or the relay station is a non-ground station such as a geostationary satellite, a medium orbit satellite, a low orbit satellite, or a high altitude platform station (HAPS). Therefore, in the non-terrestrial network, the propagation distance between the base station and the terminal device is longer than that in the terrestrial network.

In conventional cellular communication, it is not often assumed that the propagation distance between the base station or the relay station and the terminal device becomes long. Therefore, in a case where the conventional communication technology is directly applied to a non-terrestrial network, high communication performance (for example, connection stability, low delay, high reliability, high throughput, power saving, low processing load, or the like) may not be realized.

For example, it is assumed that the base station or the relay station is a satellite station. In this case, when the conventional communication technology is directly applied to the non-terrestrial network, the communication performance of the non-terrestrial network may deteriorate depending on the weather. For example, it is assumed that the weather near the terminal device on the ground connected to the satellite station is bad (for example, rain). In this case, the communication path between the satellite station and the terminal device has passed through a section with bad weather (for example, a section where rain and/or rain clouds are present.) for a long distance. In general, radio waves are susceptible to weather. For example, radio waves in a high frequency band may be greatly attenuated due to rain, fog, or the like.

Therefore, in a case where radio waves in a high frequency band are used for connection between the satellite station and the terminal device in bad weather (for example, rain), the stability of the connection between the satellite station and the terminal device may be greatly deteriorated. The same applies to a case where the base station or the relay station is the non-ground station (for example, the aircraft station) other than the satellite station.

### 1-2. Outline of Solution

Therefore, in the present embodiment, the above problem is solved by the following means. In the following description, the relay station may be referred to as the base station. The description of the base station appearing in the following description can be replaced with the relay station as appropriate.

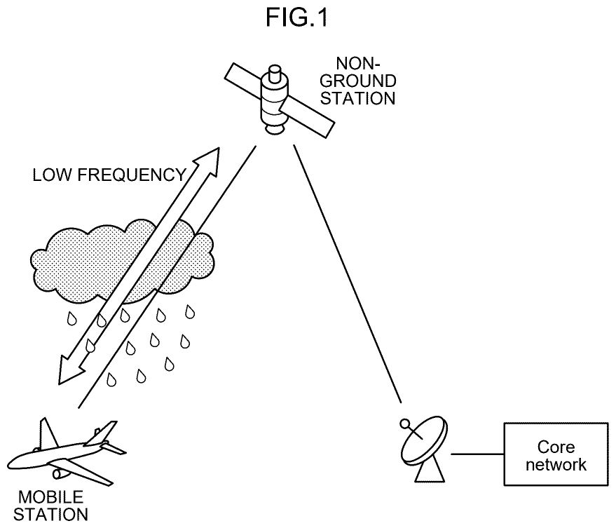

FIG. 1 is a diagram illustrating an outline of the present embodiment. The communication system of the present embodiment includes the base station and the terminal device. In the example of FIG. 1, the base station is a non-ground station such as the satellite station, and the terminal device is a mobile station such as an aircraft (alternatively, a communication device installed in the aircraft). Note that the base station and the terminal device are not limited to this example. The base station may be the ground station that communicates with the terminal device via the non-ground station (relay station). In addition, the base station or the relay station may be the non-ground station other than the satellite station. For example, the base station or the relay station may be the aircraft station. In addition, the terminal device may be the mobile station other than the aircraft. For example, the terminal device may be a mobile terminal such as a smartphone.

The terminal device of the present embodiment is configured to acquire weather information. For example, the terminal device includes one or more sensors capable of performing measurement related to weather. The one or more sensors may include, for example, at least one of a rain-sensitive sensor, a humidity sensor, and a temperature sensor. Then, the terminal device may acquire information from the one or more sensors as weather information.

In addition, the terminal device may include a storage unit that stores weather forecast information. The weather forecast information may be acquired from external weather database via a network. Then, the terminal device may acquire the weather forecast information stored in the storage unit or information generated on the basis of the weather forecast information as weather information.

Then, the terminal device makes a determination related to wireless communication with the non-ground station on the basis of the weather information. For example, in a case where the weather information indicates a predetermined state, the terminal device determines a wireless resource of a frequency satisfying a predetermined criterion as a resource to be used for wireless communication. For example, in a case where the current weather near the terminal device is rain, the terminal device determines the wireless resource of a frequency band lower than a predetermined value as the resource to be used for wireless communication.

As a result, the terminal device can be connected to the non-ground station by a communication method suitable for the weather at the time when communication is performed. For example, in the case of rain, the terminal device can be connected to the non-ground station by using the resource of a low frequency band. Therefore, the terminal device can enhance the stability of the connection with the non-ground station regardless of the weather. As a result, the terminal device can achieve high communication performance even in communication using the non-terrestrial network.

Although the outline of the present embodiment has been described above, the communication system according to the present embodiment will be described in detail below.

### 2. Configuration of Communication System

First, a configuration of a communication system 1 of the present embodiment will be described.

The communication system 1 is a cellular communication system using the radio access technology such as the LTE, the NR, or the 6G. The communication system 1 provides a terminal device on the ground with wireless communication via the non-ground station (for example, the satellite station or the aircraft station). If the non-ground station is the satellite station, the communication system 1 may be a bent-pipe (transparent) type mobile satellite communication system. Of course, some or all of the non-ground stations included in the communication system 1 may be configured to function as the base station instead of the relay station.

The radio access system used by the communication system 1 is typically the NR, but is not limited thereto.

The radio access system used by the communication system 1 may be the radio access system other than the NR, such as the 6G, the LTE, wideband code division multiple access (W-CDMA), or code division multiple access 2000 (cdma 2000).

Of course, the radio access system used by the communication system 1 may be the radio access system of the 6G or later generation.

Note that, in the present embodiment, the ground station (also referred to as a ground base station) refers to the base station (including the relay station) installed on the ground. Here, “on the ground” is on the ground in a broad sense including not only on land but also in the ground, on water, and in water. Note that, in the following description, the description of “ground station” may be replaced with “gateway”.

In addition, the technology of the present disclosure is applicable not only to communication between the non-ground base station and the terminal device but also to communication between the ground base station and the terminal device. At this time, the ground base station and the terminal device may communicate via the non-ground station such as the satellite station or the aircraft station.

Hereinafter, the configuration of the communication system 1 will be specifically described.

### 2-1. Configuration Example of Communication System

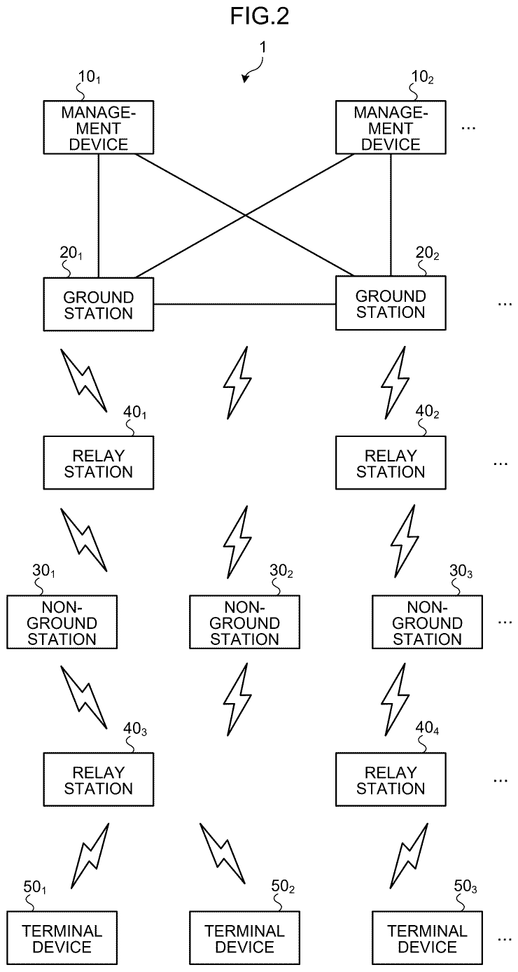

FIG. 2 is a diagram illustrating a configuration example of the communication system 1 according to an embodiment of the present disclosure. The communication system 1 includes a management device 10, a ground station 20, a non-ground station 30, a relay station 40, and a terminal device 50. The communication system 1 provides the user with a wireless network capable of mobile communication by the wireless communication devices constituting the communication system 1 operating in cooperation. The wireless network of the present embodiment includes, for example, a radio access network and a core network. Note that, in the present embodiment, the wireless communication device is a device having a wireless communication function, and corresponds to the ground station 20, the non-ground station 30, the relay station 40, and the terminal device 50 in the example of FIG. 2.

The communication system 1 may include a plurality of management devices 10, a plurality of ground stations 20, a plurality of non-ground stations 30, a plurality of relay stations 40, and a plurality of terminal devices 50. In the example of FIG. 2, the communication system 1 includes management devices 101 and 102 and the like as the management devices 10. In addition, the communication system 1 includes ground stations 201 and 202 and the like as the ground stations 20, and includes non-ground stations 301 and 302 and the like as the non-ground stations 30. In addition, the communication system 1 includes relay stations 401 and 402 and the like as the relay stations 40, and includes terminal devices 501, 502, and 503 and the like as the terminal devices 50.

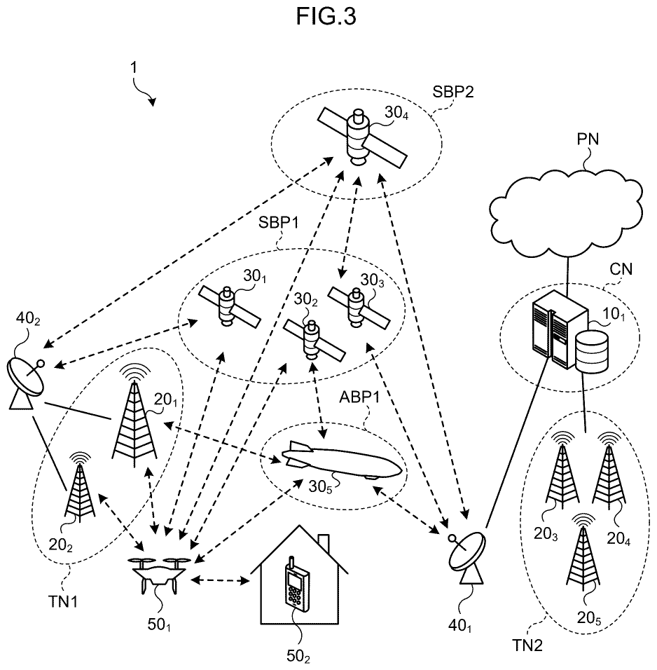

FIG. 3 is a diagram illustrating an example of the wireless network provided by the communication system 1.

The management device 10 is, for example, a device constituting a core network CN. The management device 10 is connected to a network PN. The management device 10 is connected to the ground station 20 and the non-ground station 30, and enables the terminal device 50 to be connected to the network PN. The network PN is a public data network such as the Internet. The network PN is not limited to the Internet, and may be, for example, a local area network (LAN), a wide area network (WAN), a telephone network (mobile telephone network, fixed telephone network, etc.), or a regional Internet protocol (IP) network. Of course, the network PN may be another mobile network. For example, the network PN may be a cellular network provided by an entity (for example, an entity such as a mobile network operator (MNO) ) different from the entity that operates the communication system 1.

The ground station 20 and the non-ground station 30 are the base stations or the relay stations. In the following description, the ground station 20 and the non-ground station 30 are assumed to be the base stations, but the ground station 20 and the non-ground station 30 may be the relay stations. The ground station 20 is, for example, a ground base station installed in a structure on the ground, and the non-ground station 30 is, for example, a non-ground base station such as the satellite station or a high altitude platform station (HAPS). Each of the ground station 20 and the non-ground station 30 constitutes a cell. The cell is an area that covers the wireless communication. The cell may be any of a macrocell, a microcell, a femtocell, and a small cell. Note that the communication system 1 may be configured to manage a plurality of cells by a single base station (satellite station), or may be configured to manage one cell by a plurality of base stations.

In the example of FIG. 3, the ground stations 201 and 202 constitute a terrestrial network TN1, and ground stations 203, 204, and 205 constitute a terrestrial network TN2. The terrestrial network TN1 and the terrestrial network TN2 are, for example, networks operated by a wireless communication company such as a telephone company. The terrestrial network TN1 and the terrestrial network TN2 may be operated by different wireless communication companies, or may be operated by the same wireless communication company. The terrestrial network TN1 and the terrestrial network TN2 can be regarded as one terrestrial network.

The terrestrial network TN1 and the terrestrial network TN2 are each connected to the core network. In the example of FIG. 3, the ground station 20 constituting the terrestrial network TN2 is connected to, for example, the core network CN constituted by the management device 101 and the like. If the radio access system of the terrestrial network TN2 is the LTE, the core network CN is EPC. In addition, if the radio access system of the terrestrial network TN2 is the NR, the core network CN is 5GC. Of course, the core network CN is not limited to the EPC or the 5GC, and may be a core network of another radio access system. Note that, in the example of FIG. 3, the terrestrial network TN1 is not connected to the core network, but the terrestrial network TN1 may be connected to the core network CN. In addition, the terrestrial network TN1 may be connected to a core network (not illustrated) different from the core network CN.

The core network CN includes, for example, a gateway device and an inter-gateway switch, and is connected to the network PN via the gateway device or the inter-gateway switch. As described above, the network PN is a public network such as the Internet. The gateway device may be a server device connected to the Internet, a regional IP network, or the like. The inter-gateway switch is, for example, an exchanger connected to a telephone network of a telephone company. The management device 101 may have a function as the gateway device or the inter-Gateway switch.

The non-ground station 30 illustrated in FIG. 3 is, for example, the satellite station or the aircraft station. A satellite station group (or the satellite station) constituting the non-terrestrial network is referred to as a space-borne platform. In addition, an aircraft station group (or the aircraft station) constituting the non-terrestrial network is referred to as an airborne platform. In the example of FIG. 3, the non-ground stations 301, 302, and 303 constitute a space-borne platform SBP1, and a non-ground station 304 constitutes a space-borne platform SBP2. In addition, a non-ground station 30; constitutes an airborne platform ABP1.

The non-ground station 30 may be able to communicate with the terrestrial network or the core network via the relay station 40. Of course, the non-ground station 30 may be able to directly communicate with the terrestrial network or the core network without the relay station 40. Note that the non-ground station 30 may be able to communicate with the terminal device 50 via the relay station 40, or may be able to directly communicate with the terminal device 50. In addition, the non-ground stations 30 may be able to directly communicate with each other without the relay station 40.

The relay station 40 relays communication between the device on the ground and the non-ground station 30. The relay station 40 may be the ground station or the non-ground station. In the example of FIG. 3, the relay station 402 relays communication between the ground station 20 and the non-ground station 30, and the relay station 401 relays communication between the management device 10 and the non-ground station 30. Note that the relay station 40 may relay communication between the terminal device 50 and the non-ground station 30. In addition, the relay station 40 may be able to communicate with another relay station 40.

The terminal device 50 can communicate with both the ground station and the non-ground station. In the example of FIG. 3, the terminal device 501 can communicate with the ground station constituting the terrestrial network TN1. In addition, the terminal device 501 can communicate with the non-ground station constituting the space-borne platforms SBP1 and SBP2. In addition, the terminal device 50 can also communicate with the non-ground station constituting the airborne platform ABP1. Note that the terminal device 50 may be able to communicate with the relay station 40. In addition, the terminal device 50 may be able to directly communicate with another terminal device 50. The terminal device 501 may be able to directly communicate with the terminal device 502.

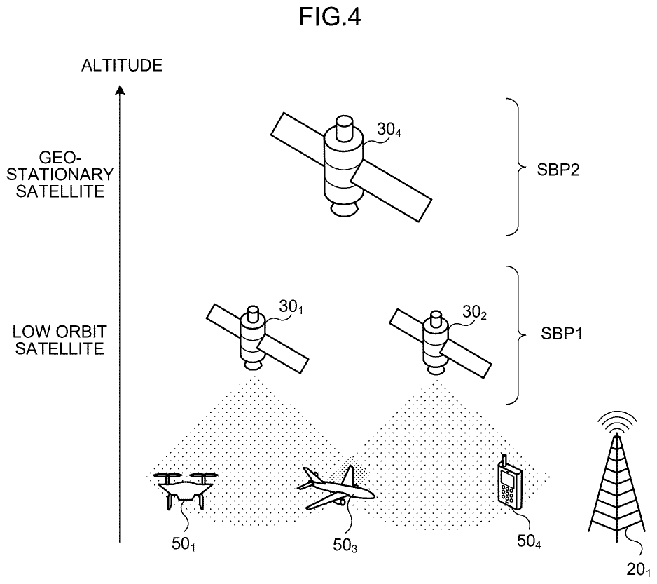

Each device constituting the space-borne platforms SBP1 and SBP2 performs satellite communication with the terminal device 50. The satellite communication is wireless communication between the satellite station and the communication device. FIG. 4 is a diagram illustrating an outline of the satellite communication provided by the communication system 1. The satellite station is mainly divided into a geostationary satellite station and a low orbit satellite station.

The geostationary satellite station is the satellite station located in a geostationary orbit and revolving around the earth at the same speed as the rotation speed of the earth. In the example of FIG. 4, the non-ground station 304 constituting the space-borne platform SBP2 is the geostationary satellite station. The geostationary orbit is an orbit at an altitude of approximately 35786 km among the satellite orbits. The geostationary orbit is also referred to as a geostationary earth orbit (GEO). The geostationary satellite station has a relative velocity of substantially zero with the terminal device 50 on the ground, and is observed as if stationary from the terminal device 50 on the ground. The non-ground station 304 performs satellite communication with the terminal devices 501, 503, 504, and the like located on the earth.

The low orbit satellite station is the satellite station that turns around a low orbit. In the example of FIG. 4, the non-ground stations 301 and 302 constituting the space-borne platform SBP1 are low orbit satellite stations. The low orbit is an orbit at an altitude of approximately 2000 km or less among the satellite orbits.

The low orbit is also referred to as low earth orbit (LEO). Unlike the geostationary satellite station, the low orbit satellite station has relative velocity with the terminal device 50 on the ground, and is observed as if moving from the terminal device 50 on the ground. The non-ground stations 301 and 302 constitute cells, respectively, and perform satellite communication with the terminal devices 501, 503, 504, and the like located on the earth.

Note that, in FIG. 4, only two non-ground stations 301 and 302 are illustrated as the satellite stations constituting the space-borne platform SBP1.

However, in practice, a satellite constellation is formed by many satellite stations. In this case, the number of satellite stations constituting the space-borne platform SBP1 is three or more (for example, several tens to several thousands).

Note that, in the example of FIG. 4, only the geostationary satellite station and the low orbit satellite station are illustrated as the satellite stations, but the satellite station constituting the communication system 1 may include a medium orbit satellite station. The medium orbit satellite station is the satellite station that turns around a medium orbit. The medium orbit is an orbit located between the low orbit and the geostationary orbit. The medium orbit is also referred to as a medium earth orbit (MEO). In addition, the satellite station constituting the communication system 1 may include a highly elliptical orbiting satellite station located in a highly elliptical orbiting (HEO). Note that the satellite station forming the satellite constellation may include not only the low orbit satellite station but also the medium orbit satellite station, the highly elliptical orbiting satellite station, and the geostationary satellite station.

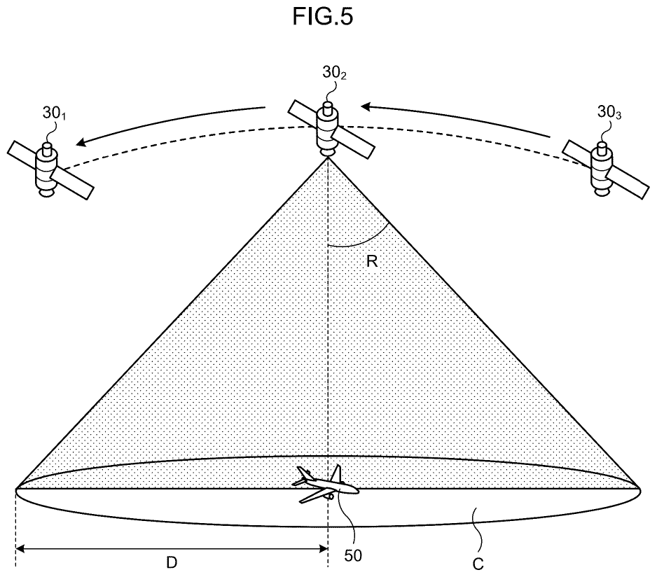

FIG. 5 is a diagram illustrating an example of a cell configured by a non-geostationary satellite. FIG. 5 illustrates a cell C formed by the non-ground station 302. In the example of FIG. 5, the non-ground station 302 is the low orbit satellite station. The satellite station turning around the low orbit communicates with the terminal device 50 on the ground with a predetermined directivity on the ground. For example, in the example illustrated in FIG. 5, an angle R is 40 degrees. In a case of the example of FIG. 5, a radius D of the cell C formed by the non-ground station 302 is, for example, 1000 km. The low orbit satellite station moves with constant velocity. When it becomes difficult for the low orbit satellite station to provide the satellite communication to the terminal device 50 on the ground, a subsequent low orbit satellite station (neighbor satellite station) provides the satellite communication. In a case of the example of FIG. 5, when it becomes difficult for the non-ground station 302 to provide the satellite communication to the terminal device 50 on the ground, the subsequent non-ground station 303 provides the satellite communication. Note that the values of the angle R and the radius D described above are merely examples, and are not limited to the above.

The medium orbit satellite and the low orbit satellite move on the orbit in the sky at very high speed. For example, the low orbit satellite at an altitude of 600 km is moving on the orbit at speed of 7.6 km/S. The low orbit satellite forms a cell (or beam) having a radius of several 10 km to several 100 km on the ground, but since the cell formed on the ground also moves in accordance with the movement of the satellite, handover may be required even if the terminal device on the ground does not move.

For example, assuming a case where a cell diameter formed on the ground is 50 km and the terminal device on the ground is not moving, the handover occurs in about 6 to 7 seconds.

As described above, the terminal device 50 can perform wireless communication using the non-terrestrial network. In addition, the non-ground station 30 of the communication system 1 constitutes the non-terrestrial network. As a result, the communication system 1 can extend the service to the terminal device 50 located in an area that cannot be covered by the terrestrial network.

For example, the communication system 1 can provide public safety communication and critical communication to the communication device such as an Internet of Things (IoT) device or a machine type communications (MTC) device. In addition, since service reliability and recoverability are improved by using the non-terrestrial network, the communication system 1 can reduce service vulnerability to physical attacks or natural disasters. In addition, the communication system 1 can realize service connection to airplane passengers and aircraft terminal devices such as drones, and service connection to mobile terminal devices such as ships and trains. In addition, the communication system 1 can realize provision of A/V content, group communication, an IoT broadcast service, a software download service, a high-efficiency multicast service such as an emergency message, a high-efficiency broadcast service, and the like.

Furthermore, the communication system 1 can also realize traffic off-load between the terrestrial network and the non-terrestrial network.

In order to realize these, it is desirable that the non-terrestrial network provided by the communication system 1 is subjected to operation integration with the terrestrial network in an upper layer. In addition, the non-terrestrial network provided by the communication system 1 desirably has a radio access system common to the terrestrial network.

Note that the device in the drawing may be considered as a device in a logical sense. That is, a part of the device in the drawing may be implemented by a virtual machine (VM), a container, a docker, or the like, and they may be implemented on physically the same hardware.

In addition, in the present embodiment, the ground station and the non-ground station can be rephrased as the base stations. The satellite station can be rephrased as the relay station. If the satellite station has a function as the base station, the satellite station can be rephrased as the base station.

Note that, in the following description, the terminal device may be referred to as user equipment (UE). The terminal device is a type of the communication device, and is also referred to as a mobile station or a terminal.

In the present embodiment, the concept of the communication device includes not only a portable mobile device (terminal device) such as a mobile terminal but also a device installed in a structure or a mobile body. The Structure or the mobile body itself may be regarded as a communication device. In addition, the concept of the communication device includes not only the terminal device but also the base station and the relay station. The communication device is a type of a processing device and an information processing device. In addition, the communication device can be rephrased as a transmission device or a reception device.

Hereinafter, a configuration of each device constituting the communication system 1 will be specifically described. Note that the configuration of each device described below is merely an example. The configuration of each device may be different from the following configuration.

### 2-2. Configuration Example of Management Device

Next, a configuration of the management device 10 will be described.

The management device 10 is a device that manages a wireless network. For example, the management device 10 is a device constituting the core network. When the core network is the EPC, the management device 10 is, for example, a device having a function as a mobility management entity (MME). In addition, if the core network is the 5GC, the management device 10 is, for example, a device having a function as an access and mobility management function (AMF) and/or a session management function (SMF). The MME, the AMF, and the SMF are control plane network function nodes in the core network. The management device 10 may be a device having a function as a control plane network function (6G CPNF) in the 6G. The 6G CPNF may be formed of one or more logical nodes.

Of course, the functions of the management device 10 are not limited to the MME, the AMF, the SMF, and the 6G CPNF. For example, if the core network is the 5GC, the management device 10 may be a device having a function as a network slice selection function (NSSF), an authentication server function (AUSF), a policy control function (PCF), or a unified data management (UDM). In addition, the management device 10 may be a device having a function as a home subscriber server (HSS).

Note that the management device 10 may have a function of a gateway. For example, the management device 10 may have a function as a serving gateway (S-GW) or a packet data network gateway (P-GW). In addition, the management device 10 may have a function of a user plane function (UPF). At this time, the management device 10 may have a plurality of UPFs. In addition, the management device 10 may be a device having a function as a user plane network function (6G UPNF) in the 6G.

The core network includes a plurality of network functions, and each network function may be aggregated into one physical device or distributed to a plurality of physical devices. That is, the management device 10 can be dispersedly arranged in a plurality of devices.

Furthermore, this dispersed arrangement may be controlled to be performed dynamically. The base station (the ground station 20 and/or the non-ground station 30) and the management device 10 constitute one network, and provide a wireless communication service to the terminal device 50. The management device 10 is connected to the network PN such as the Internet. The terminal device 50 can use various services provided via the network PN.

Note that the management device 10 is not necessarily a device constituting the core network. For example, it is assumed that the core network is a core network of wideband code division multiple access (W-CDMA) or code division multiple access 2000 (cdma 2000). At this time, the management device 10 may be a device that functions as a radio network controller (RNC).

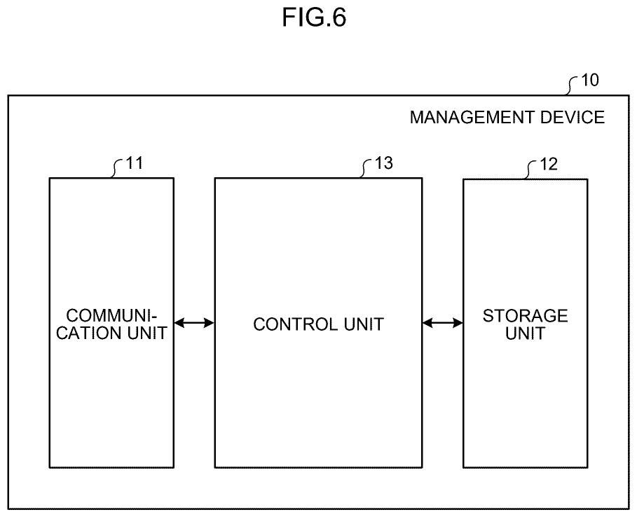

FIG. 6 is a diagram illustrating a configuration example of the management device 10 according to an embodiment of the present disclosure. The management device 10 includes a communication unit 11, a storage unit 12, and a control unit 13. Note that the configuration illustrated in FIG. 6 is a functional configuration, and the hardware configuration may be different from the functional configuration. In addition, the functions of the management device 10 may be implemented by being dispersed into a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC), or may be a USB interface including a universal serial bus (USB) host controller, a USB port, and the like. In addition, the communication unit 11 may be a wired interface or a wireless interface. The communication unit 11 functions as a means of communication of the management device 10. The communication unit 11 communicates with the ground station 20 and the like under the control of the control unit 13.

The storage unit 12 is a data readable/writable storage device such as a dynamic random access memory (DRAM), a static random access memory (SRAM), a flash memory, or a hard disk. The storage unit 12 functions as a means of storage of the management device 10. The storage unit 12 stores, for example, a connection state of the terminal device 50. For example, the storage unit 12 stores a radio resource control (RRC) state and an EPS connection management (ECM) state of the terminal device 50. The storage unit 12 may function as a home memory that stores the position information of the terminal device 50.

The control unit 13 is a controller that controls each unit of the management device 10. The control unit 13 is realized by, for example, a processor such as a central processing unit (CPU), a micro processing unit (MPU), or a graphics processing unit (GPU). For example, the control unit 13 is realized by the processor executing various programs stored in the storage device inside the management device 10 using a random access memory (RAM) or the like as a work area. Note that the control unit 13 may be realized by an integrated circuit such as an application specific integrated circuit (ASIC) or a field programmable gate array (FPGA). In addition, the control unit 13 may be realized by the GPU. Any of the CPU, the MPU, the ASIC, the FPGA, and the GPU can be regarded as a controller. Note that the control unit 13 may include a plurality of physically separated objects. For example, the control unit 13 may include a plurality of semiconductor chips.

Note that the operation of the control unit 13 may be similar to the operation of a control unit 23 of the ground station 20, or may be similar to the operation of a control unit 33 of the non-ground station 30. In addition, the operation of the control unit 13 may be similar to the operation of a control unit 43 of the relay station 40, or may be similar to the operation of a control unit 53 of the terminal device 50.

### 2-3. Configuration Example of Ground Station

First, the configuration of the ground station 20 will be described.

The ground station 20 is a wireless communication device that wirelessly communicates with the terminal device 50. The ground station 20 may be configured to wirelessly communicate with the terminal device 50 via the non-ground station 30, or may be configured to wirelessly communicate with the terminal device 50 via the relay station on the ground. Of course, the ground station 20 may be configured to directly wirelessly communicate with the terminal device 50.

The ground station 20 is a type of the communication device. More specifically, the ground station 20 is a device corresponding to a wireless base station (base station, node B, eNB, gNB, 6GNB, etc.) or a wireless access point. The ground station 20 may be a wireless relay station. In addition, the ground station 20 may be an extension device (for example, a light projecting device) called a remote radio head (RRH) or a radio unit (RU). In addition, the ground station 20 may be a receiving station such as a field pickup unit (FPU). In addition, the ground station 20 may be an integrated access and backhaul (IAB) donor node or an IAB relay node that provides a wireless access line and a wireless backhaul line by time division multiplexing, frequency division multiplexing, or space division multiplexing.

Note that the radio access technology used by the ground station 20 may be a cellular communication technology or a radio LAN technology. Of course, the radio access technology used by the ground station 20 is not limited thereto, and may be another radio access technology. For example, the radio access technology used by the ground station 20 may be a low power wide area (LPWA) communication technology. In addition, the wireless communication used by the ground station 20 may be wireless communication using a millimeter wave or wireless communication using a TERA wave (terahertz wave). In addition, the wireless communication used by the ground station 20 may be wireless communication using radio waves or wireless communication (optical wireless) using infrared rays or visible light.

The ground station 20 may be able to perform non-orthogonal multiple access (NOMA) communication with the terminal device 50. Here, the NOMA communication is communication using a non-orthogonal resource (transmission, reception, or both). Note that the ground station 20 may be able to perform NOMA communication with another ground station 20. Here, the non-orthogonal resource is a resource of an axis different from the orthogonal resource (time, frequency, and space), and is, for example, a wireless resource capable of separating different signals by using scrambling, interleaving, a code (for example, a spreading code, a sparse code, or the like), a power difference, and the like.

Note that the ground stations 20 may be able to communicate with each other via an interface between the base station and the core network (for example, S1 interface or the like). This interface may be either wired or wireless. In addition, the base stations may be able to communicate with each other via an inter-base station interface (for example, X2 interface, Xn interface, X2 interface, F1 interface, and the like). This interface may be either wired or wireless.

Note that the concept of the base station (also referred to as a base station device) includes not only a donor base station but also a relay base station (also referred to as a relay station or a relay station). At this time, the relay base station may be any one of RF Repeater, Smart Repeater, and Intelligent Surface. In addition, the concept of the base station includes not only a structure having a function of the base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. Note that the concept of the structure includes not only a building but also a construction (non-building structure) such as a tunnel, a bridge, a dam, a wall, or an iron pillar, and equipment such as a crane, a gate, or a windmill. In addition, the concept of the structure includes not only a structure on land (on the ground in a narrow sense) or in the ground, but also a structure on water such as a platform or a mega-float, and a structure under water such as a marine observation facility. The base station may be rephrased as an information processing device.

The ground station 20 may be a donor station or a relay station. In addition, the ground station 20 may be a fixed station or a mobile station. The mobile station is a wireless communication device (for example, a base station) configured to be movable. At this time, the ground station 20 may be a device installed in a mobile body or may be a mobile body itself. For example, a relay station having mobility can be regarded as the ground station 20 serving as a mobile station. In addition, a device that is originally capable of moving, such as a vehicle, an unmanned aerial vehicle (UAV), or a smartphone, and has a function of a base station (at least a part of the function of the base station) also corresponds to the ground station 20 serving as a mobile station. An example of the UAV includes a drone.

Here, the mobile body may be a mobile terminal such as a smartphone or a mobile phone. In addition, the mobile body may be a mobile body (for example, a vehicle such as an automobile, a bicycle, a bus, a truck, a motorcycle, a train, or a linear motor car) that moves on land (on the ground in a narrow sense) or a mobile body (for example, the subway) that moves in the ground (for example, in the tunnel). In addition, the mobile body may be a mobile body (for example, a ship such as a passenger ship, a cargo ship, or a hovercraft) that moves over water or a mobile body (for example, submersibles such as submersibles, submarine boat, and unmanned submersibles) that moves under water. In addition, the mobile body may be a mobile body (for example, an aircraft such as an airplane, an airship, or a drone) that moves inside the atmosphere.

In addition, the ground station 20 may be the ground base station installed on the ground. For example, the ground station 20 may be a base station arranged in a structure on the ground, or may be a base station installed in a mobile body moving on the ground. More specifically, the ground station 20 may be an antenna installed in the structure such as a building and a signal processing device connected to the antenna. Of course, the ground station 20 may be a structure or a mobile body itself. “On the ground” is on the ground in a broad sense including not only on land (on the ground in a narrow sense) but also in the ground, on water, and in water. Note that the ground station 20 is not limited to the ground base station. For example, in a case where the communication system 1 is a satellite communication system, the ground station 20 may be an aircraft station. Seen from the satellite station, the aircraft station located on the earth is the ground station.

The coverage of the ground station 20 may be large such as a macrocell or small such as a pico cell. Of course, the coverage of the ground station 20 may be extremely small, such as the femtocell. In addition, the ground station 20 may have a beamforming capability. In this case, the ground station 20 may form a cell or a service area for each beam. For this purpose, the ground station 20 may be equipped with an antenna array including a plurality of antenna elements, and may be configured to provide an advanced antenna technology typified by multiple input multiple output (MIMO) and beamforming.

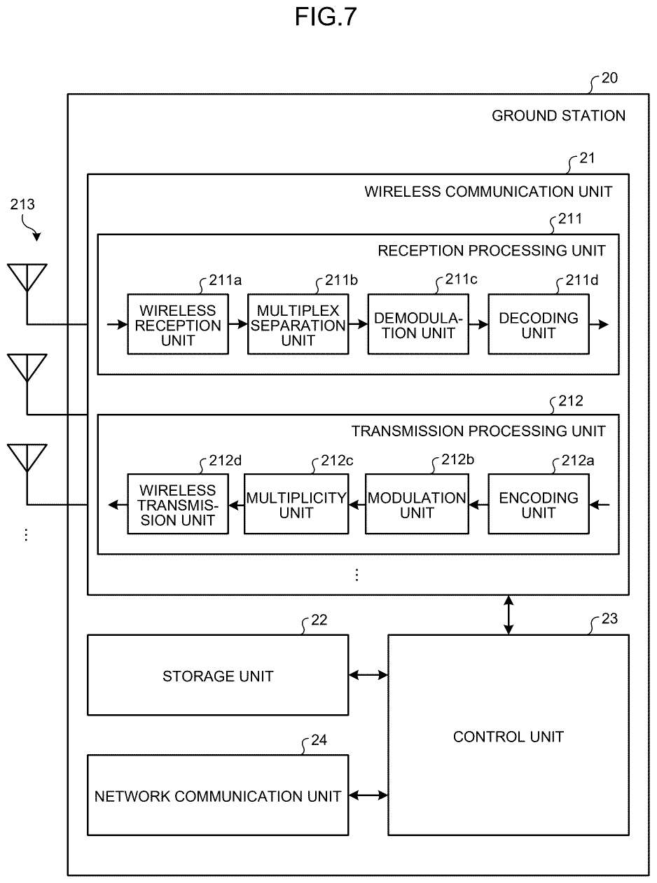

FIG. 7 is a diagram illustrating a configuration example of the ground station 20 according to an embodiment of the present disclosure. The ground station 20 includes a wireless communication unit 21, a storage unit 22, a control unit 23, and a network communication unit 24. Note that the configuration illustrated in FIG. 7 is a functional configuration, and the hardware configuration may be different from the functional configuration. In addition, the functions of the ground station 20 may be implemented by being dispersed into the plurality of physically separated configurations.

The wireless communication unit 21 is a signal processing unit for wirelessly communicating with other wireless communication devices (for example, the non-ground station 30, the relay station 40, the terminal device 50, and another ground station 20). The wireless communication unit 21 operates under the control of the control unit 23. The wireless communication unit 21 corresponds to one or more radio access systems. For example, the wireless communication unit 21 corresponds to at least one of the NR, the LTE, and the 6G. The wireless communication unit 21 may correspond to the W-CDMA and/or the cdma 2000 in addition to the NR, the LTE, and the 6G. In addition, the wireless communication unit 21 may correspond to an automatic retransmission technology such as hybrid automatic repeat request (HARQ).

The wireless communication unit 21 includes a reception processing unit 211, a transmission processing unit 212, and an antenna 213. The wireless communication unit 21 may include a plurality of reception processing units 211, a plurality of transmission processing units 212, and a plurality of antennas 213. Note that, in a case where the wireless communication unit 21 corresponds to a plurality of radio access systems, each unit of the wireless communication unit 21 can be configured individually for each radio access system. For example, the reception processing unit 211 and the transmission processing unit 212 may be individually configured by the LTE, the NR, and the 6G. In addition, the antenna 213 may include a plurality of antenna elements (for example, a plurality of patch antennas). In this case, the wireless communication unit 21 may be configured to be beam-formable. The wireless communication unit 21 may be configured to enable polarization beamforming using vertically polarized waves (V-polarized waves) and horizontally polarized waves (H-polarized waves).

The reception processing unit 211 processes the uplink signal received via the antenna 213. For example, the reception processing unit 211 performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal.

Then, from the signals subjected to these processing, the reception processing unit 211 separates an uplink channel such as a physical uplink shared channel (PUSCH) and a physical uplink control channel (PUCCH) and an uplink reference signal. In addition, the reception processing unit 211 demodulates the received signal using a modulation system such as binary phase shift keying (BPSK) or quadrature phase shift keying (QPSK) with respect to the modulation symbol of the uplink channel. The modulation system used for demodulation may be 16 quadrature amplitude modulation (QAM), 64 QAM, 256 QAM, or 1024 QAM. In this case, the signal points on the constellation do not necessarily have to be equidistant. The constellation may be a non uniform constellation (NUC). Then, the reception processing unit 211 performs decoding processing on the demodulated encoded bits of the uplink channel. The decoded uplink data and uplink control information are output to the control unit 23.

The transmission processing unit 212 performs processing of transmitting the downlink control information and the downlink data. For example, the transmission processing unit 212 encodes the downlink control information and the downlink data input from the control unit 23 using an encoding system such as block encoding, convolutional encoding, turbo encoding, or the like. Here, the encoding may be, for example, encoding with a polar code or encoding with a low density parity check code (LDPC code). Then, the transmission processing unit 212 modulates the encoded bits by a predetermined modulation system such as BPSK, QPSK, 16 QAM, 64 QAM, 256 QAM, or 1024 QAM. In this case, the signal points on the constellation do not necessarily have to be equidistant. The constellation may be a non-uniform constellation (NUC).

Then, the transmission processing unit 212 multiplexes the modulation symbols of each channel and the downlink reference signals and arranges the multiplexed symbols and signals in a predetermined resource element. Then, the transmission processing unit 212 performs various types of signal processing on the multiplexed signals. For example, the transmission processing unit 212 performs processing such as conversion into a time domain by fast Fourier transform, addition of a guard interval (cyclic prefix), generation of a baseband digital signal, conversion into an analog signal, quadrature modulation, up-conversion, removal of an extra frequency component, and amplification of power. The signal generated by the transmission processing unit 212 is transmitted from the antenna 213.

The antenna 213 is an antenna device (antenna unit) that mutually converts current and a radio wave. The antenna 213 may include one antenna element (for example, one patch antenna) or may include a plurality of antenna elements (for example, a plurality of patch antennas). In a case where the antenna 213 includes the plurality of antenna elements, the wireless communication unit 21 may be configured to be beam-formable. For example, the wireless communication unit 21 may be configured to generate a directional beam by controlling the directivity of a wireless signal using the plurality of antenna elements. Note that the antenna 213 may be a dual-polarized antenna. In a case where the antenna 213 is the dual-polarized antenna, the wireless communication unit 21 may use dual-polarized waves including vertically polarized waves (V-polarized waves) and horizontally polarized waves (H-polarized waves) in transmitting wireless signals. In addition, the wireless communication unit 21 may use the dual polarized waves including polarized waves of 45 degrees and −45 degrees from the vertical direction in transmitting wireless signals. Then, the wireless communication unit 21 may control the directivity of the wireless signal transmitted using the dual polarized waves. In addition, the wireless communication unit 21 may transmit and receive spatially multiplexed signals via a plurality of layers including the plurality of antenna elements.

The storage unit 22 is a storage device capable of reading and writing data, such as a DRAM, an SRAM, a flash memory, or a hard disk. The storage unit 22 functions as a means of storage of the ground station 20.

The control unit 23 is a controller that controls each unit of the ground station 20. The control unit 23 is realized by, for example, a processor such as the CPU, the MPU, or the GPU. For example, the control unit 23 is realized by the processor executing various programs stored in the storage device inside the ground station 20 using the RAM or the like as a work area. Note that the control unit 23 may be realized by an integrated circuit such as the ASIC or the FPGA. In addition, the control unit 23 may be realized by the GPU. Any of the CPU, the MPU, the ASIC, the FPGA, and the GPU can be regarded as a controller. Note that the control unit 23 may include a plurality of physically separated objects. For example, the control unit 23 may include a plurality of semiconductor chips.

Note that the operation of the control unit 23 of the ground station 20 may be similar to the operation of the control unit 33 of the non-ground station 30. At this time, the control unit 23 of the ground station 20 may have a configuration similar to a functional block (to be described later) of the control unit 33 of the non-ground station 30. Of course, the operation of the control unit 33 of the non-ground station 30 may be the same as the operation of the control unit 23 of the ground station 20. In addition, the operation of the control unit 23 may be similar to the operation of the control unit 43 of the relay station 40, may be similar to the operation of the control unit 13 of the management device 10, or may be similar to the operation of the control unit 53 of the terminal device 50.

The network communication unit 24 is a communication interface for communicating with other devices. The network communication unit 24 is, for example, a network interface. For example, the network communication unit 24 is the LAN interface such as the NIC. Note that the network communication unit 24 may be a wired interface or a wireless interface. The network communication unit 24 functions as a means of communication of the ground station 20. The network communication unit 24 communicates with the management device 10, the relay station 40, and the like under the control of the control unit 23.

### 2-4. Configuration Example of Non-ground Station

Next, a configuration of the non-ground station 30 will be described.

The non-ground station 30 is a base station that provides the terminal device 50 with a function of the base station. Alternatively, the non-ground station 30 is a relay station that relays communication between the ground station 20 and the terminal device 50. The non-ground station 30 may be a satellite station or an aircraft station.

The satellite station is a satellite station capable of floating outside the atmosphere. The satellite station may be a device mounted on a spatial mobile body such as an artificial satellite, or may be a spatial mobile body itself. The spatial mobile body is a mobile body that moves outside the atmosphere. Examples of the spatial mobile bodies include artificial celestial bodies such as an artificial satellite, a spacecraft, a space station, and a probe.

Note that the satellite serving as the satellite station may be any of the low orbit satellite, the medium orbit satellite, and the geostationary satellite. In addition, the satellite serving as the satellite station may be a highly elliptical orbiting satellite that turns around a highly elliptical orbiting (HEO). Of course, the satellite station may be a communication device mounted on these satellites.

The aircraft station is a wireless communication device capable of floating inside the atmosphere, such as an aircraft. The aircraft station may be a device mounted on an aircraft or the like, or may be an aircraft itself.

Note that the concept of the aircraft includes not only heavy aircraft such as an airplane and a glider but also light aircraft such as a balloon and an airship. In addition, the concept of the aircraft includes not only the heavy aircraft and the light aircraft but also a rotorcraft such as a helicopter and an autogyro. Note that the aircraft station (alternatively, an aircraft on which an aircraft station is mounted) may be the unmanned aerial vehicle (UAV) such as a drone.

Note that the concept of the unmanned aerial vehicle also includes unmanned aircraft systems (UAS) and a tethered UAS. In addition, the concept of the unmanned aerial vehicle also includes a lighter than air (LTA) UAS and a heavy than air (HTA) UAS. In addition, the concept of the unmanned aerial vehicles also includes high altitude UAS platforms (HAPs).

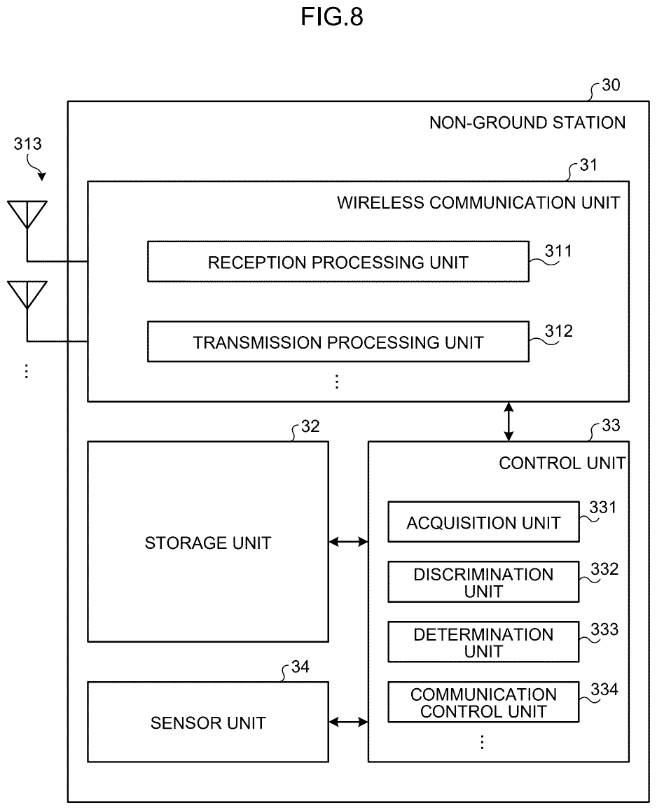

FIG. 8 is a diagram illustrating a configuration example of the non-ground station 30 according to an embodiment of the present disclosure. The non-ground station 30 includes a wireless communication unit 31, a storage unit 32, the control unit 33, and a sensor unit 34. Note that the configuration illustrated in FIG. 8 is a functional configuration, and the hardware configuration may be different from the functional configuration. In addition, the functions of the non-ground station 30 may be implemented by being dispersed into the plurality of physically separated configurations.

The wireless communication unit 31 is a wireless communication interface that wirelessly communicates with other wireless communication devices (for example, the ground station 20, the relay station 40, the terminal device 50, and another non-ground station 30). The wireless communication unit 31 corresponds to one or more radio access systems. For example, the wireless communication unit 31 corresponds to at least one of the NR, the LTE, and the 6G. The wireless communication unit 31 may correspond to the W-CDMA and/or a cdma 3000 in addition to the NR, the LTE, and the 6G.

The wireless communication unit 31 includes a reception processing unit 311, a transmission processing unit 312, and an antenna 313. The wireless communication unit 31 may include a plurality of reception processing units 311, a plurality of transmission processing units 312, and a plurality of antennas 313. Note that, in a case where the wireless communication unit 31 corresponds to the plurality of radio access systems, each unit of the wireless communication unit 31 can be configured individually for each radio access system. For example, the reception processing unit 311 and the transmission processing unit 312 may be individually configured by the LTE, the NR, and the 6G. The configurations of the reception processing unit 311, the transmission processing unit 312, and the antenna 313 are similar to the configurations of the reception processing unit 211, the transmission processing unit 212, and the antenna 213 described above. Note that the wireless communication unit 31 may be configured to be beam-formable similarly to the wireless communication unit 21. At this time, the wireless communication unit 31 may be configured to be polarization beam-formable similarly to the wireless communication unit 21. In addition, similarly to the wireless communication unit 21, the wireless communication unit 31 may be configured to be able to transmit and receive spatially multiplexed signals.

The storage unit 32 is a storage device capable of reading and writing data, such as the DRAM, the SRAM, the flash memory, or the hard disk. The storage unit 32 functions as a means of storage of the non-ground station 30.

The control unit 33 is a controller that controls each unit of the non-ground station 30. The control unit 33 is realized by, for example, the processor such as the CPU, the MPU, or the GPU. For example, the control unit 33 is realized by the processor executing various programs stored in a storage device inside the non-ground station 30 using the RAM or the like as a work area. Note that the control unit 33 may be realized by the integrated circuit such as the ASIC or the FPGA. In addition, the control unit 33 may be realized by the GPU. Any of the CPU, the MPU, the ASIC, the FPGA, and the GPU can be regarded as a controller. Note that the control unit 33 may include a plurality of physically separated objects. For example, the control unit 33 may include a plurality of semiconductor chips.

The control unit 33 includes an acquisition unit 331, a discrimination unit 332, a determination unit 333, and a communication control unit 334. Each block (the acquisition unit 331 to the communication control unit 334) constituting the control unit 33 is a functional block indicating a function of the control unit 33. These functional blocks may be software blocks or hardware blocks. For example, each of the above-described functional blocks may be one software module realized by software (including microprogram), or may be one circuit block on a semiconductor chip (die). Of course, each functional block may be one processor or one integrated circuit. The control unit 33 may be configured by a functional unit different from the above-described functional block. A configuration method of the functional block is arbitrary.

Note that the operation of each block (the acquisition unit 331 to the communication control unit 334) constituting the control unit 33 may be similar to the operation of (the acquisition unit 531 to the communication control unit 534) included in the control unit 53 of the terminal device 50. In addition, the operation of the control unit 33 may be similar to the operation of the control unit 13 of the management device 10, may be similar to the operation of the control unit 23 of the ground station 20, or may be similar to the operation of the control unit 43 of the relay station 40.

The sensor unit 34 includes one or more of sensors that perform measurement related to weather. The sensor unit 34 may include a visible sensor that measures the shape or brightness of the cloud. In addition, the sensor unit 34 may include an infrared sensor (or a heat sensor) that measures the temperature of the cloud, the sea, or the land. A mid-infrared sensor that measures the distribution of water vapor in the atmosphere may be included. In addition, the sensor unit 34 may include a sensor similar to the sensor included in a sensor unit 54 of the terminal device 50 to be described later.

### 2-5. Configuration Example of Base Station

At least one of the ground station 20 and the non-ground station 30 may operate as a base station. In a case where the ground station 20 is a base station, the non-ground station 30 can function as a relay station that relays communication between the base station and the terminal device 50. The ground station 20 can also function as a relay station that relays communication between the base station and the terminal device 50. In a case where the ground station 20 and/or the non-ground station 30 is a relay station, the configuration of the ground station 20 and/or the non-ground station 30 may be similar to the configuration of the relay station 40 to be described later. Hereinafter, the base station will be described.

In the present embodiment, the concept of the base station may include aggregation of a plurality of physical or logical devices. For example, in the present embodiment, the base stations may be distinguished into a plurality of devices of a baseband unit (BBU) and a radio unit (RU), and may be interpreted as aggregation of these plurality of devices. In addition, in the embodiments of the present disclosure, the base station may be either or both of the BBU and the RU.

The BBU and the RU may be connected by a predetermined interface (for example, eCPRI). The RU may be referred to as remote radio unit (RRU) or radio DoT (RD). The RU may be compatible with a gNB distributed unit (gNB-DU) to be described later. The BBU may be compatible with a gNB central unit (gNB-CU) to be described later. The RU may be a wireless device connected to the gNB-DU to be described later. The gNB-CU, the gNB-DU, and the RU connected to the gNB-DU may be configured to conform to an open wireless access network (O-RAN). The RU may be a device integrally formed with an antenna.

An antenna (for example, the antenna integrally formed with the RU) included in the base station may adopt an advanced antenna system and support MIMO (for example, FD-MIMO) or beamforming. In this case, the antenna (for example, the antenna integrally formed with the RU) included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two types of antenna panels of a horizontally polarized antenna panel and a vertically polarized antenna panel, or two types of antenna panels of a clockwise circularly polarized antenna panel and a counterclockwise circularly polarized antenna panel. In addition, the RU may form and control an independent beam for each antenna panel.

Note that a plurality of base stations may be connected to each other. The one or more base stations may be included in a radio access network (RAN). That is, the base station may be simply referred to as a RAN, a RAN node, an access network (AN), or an AN node. The RAN in the LTE is referred to as an enhanced universal terrestrial RAN (EUTRAN). The RAN in the NR is referred to as NGRAN.

The RAN in the W-CDMA (UMTS) is referred to as UTRAN.

The base station of the LTE is sometimes referred to as an evolved node B (eNodeB) or an eNB. At this time, the EUTRAN includes one or more eNodeBs (eNBs). In addition, an NR base station is sometimes referred to as a gNodeB or a gNB. At this time, the NGRAN includes one or more gNBs. A 6G base station is sometimes referred to as a 6GNodeB, a 6gNodeB, a 6GNB, or a 6gNB. At this time, the 6GRAN includes one or more 6GNBs. The EUTRAN may include a gNB (en-gNB) connected to the core network (EPC) in an LTE communication system (EPS). Similarly, the NGRAN may include an ng-eNB connected to a core network 5GC in a 5G communication system (5GS).

Note that, in a case where the base station is the eNB, the gNB, or the 6GNB, the base station is sometimes referred to as 3GPP access. In addition, in a case where the base station is a wireless access point (access point), the base station is sometimes referred to as non-3GPP access. In addition, the base station may be an optical extension device called a remote radio head (RRH) or a radio unit (RU). In addition, in a case where the base station is the gNB, the base station may be a combination of the above-described gNB central unit (gNB-CU) and gNB distributed unit (gNB-DU), or any one of the gNB-CU and the gNB-DU.

Here, the gNB-CU hosts a plurality of upper layers in an access stratum for communication with the UE. Here, the upper layer is, for example, radio link control (RRC), service data adaptation protocol (SDAP), or packet data convergence protocol (PDCP). On the other hand, the gNB-DU hosts a plurality of lower layers in the access stratum. Here, the lower layer is, for example, radio link control (RLC), medium access control (MAC), or physical layer (PHY). That is, a part of the message/information may be generated by the gNB-CU as RRC signaling (quasi-static notification), and the rest may be generated by the gNB-DU as MAC CE or DCI (dynamic notification). In addition, in the RRC configuration (quasi-static notification), for example, some configurations such as IE: cellGroupConfig may be generated by the gNB-DU, and the remaining configurations may be generated by the gNB-CU.

These configurations may be transmitted and received through an F1 interface.

The base station may be configured to be able to communicate with other base stations. For example, in a case where the plurality of base stations is eNBs or a combination of the eNB and the en-gNB, the base stations may be connected through an X2 interface. For example, in a case where the plurality of base stations is eNBs or a combination of the eNB and the the-gNB, the devices may be connected through an Xn interface. In a case where the plurality of base stations is a combination of the gNB central unit (gNB-CU) and the gNB distributed unit (gNB-DU), the devices may be connected through the above-described F1 interface. The message/information (for example, RRC signaling, MAC control element (MAC CE), or downlink control information (DCI) ) to be described later may be communicated between the plurality of base stations, for example, via the X2, Xn, and F1 interfaces.

For example, in the following embodiments, the ground station and the non-ground station may be (1) both gNBs or both eNBs. In the following embodiment, one may be the gNB and the other may be the eNB. In addition, in the following embodiment, one may be the gNB-CU and the other may be the gNB-DU. In a case where the non-ground station is the gNB and the ground station is the eNB, the gNB of the non-ground station (satellite station) may perform connected mobility (handover) or dual connectivity by coordination (for example, X2 signaling, Xn signaling) with the eNB of the ground station. In addition, in a case where the non-ground station is the gNB-DU and the ground station is the gNB-CU, the gNB-DU of the non-ground station (satellite station) may constitute a logical gNB by coordination (for example, F1 signaling) with the gNB-CU of the ground station.

A cell provided by the base station is referred to as a serving cell. The serving cell includes a primary cell (PCell) and a secondary cell (SCell). In a case where the dual connectivity is set in the UE (for example, the terminal device 50), the PCell provided by the master node (MN) and zero or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity (NNDC). Furthermore, examples of the dual connectivity include NR-6G dual connectivity and 6G-NR dual connectivity.

Note that the serving cell may include a primary secondary cell or a primary SCG cell (PSCell). In other words, when the dual connectivity is set in the UE, the PSCell provided by the secondary node (SN) and zero or one or more SCells may be referred to as a secondary cell group (SCG).

Unless specially set (for example, PUCCH on SCell), the physical uplink control channel (PUCCH) is transmitted in the PCell and the PSCell, but is not transmitted in the SCell. In addition, a radio link failure is also detected in the PCell and the PSCell, but is not detected in the SCell (do not necessarily have to be detected). As described above, since the PCell and the PSCell have a special role in the serving cell, they are also referred to as a special cell (SpCell).

One downlink component carrier and one uplink component carrier may be associated with one cell. In addition, the system bandwidth corresponding to one cell may be divided into a plurality of bandwidth parts (BWPs). In this case, one or more BWPs may be set in the UE, and one BWP may be used for the UE as an active BWP. In addition, wireless resources (for example, a frequency band, a numerology (subcarrier spacing), and a slot format (slot configuration) ) that can be used by the terminal device 50 may be different for each cell, each component carrier, or each BWP.

### 2-6. Configuration Example of Relay Station

Next, a configuration of the relay station 40 will be described.

The relay station 40 is a wireless communication device that wirelessly communicates with other communication devices such as the management device 10, the ground station 20, the non-ground station 30, and the terminal device 50. The relay station 40 relays communication between the non-ground station 30 and a communication device (for example, the management device 10, the ground station 20, or the terminal device 50) on the ground. The relay station 40 may be the ground station or the non-ground station. At this time, the relay station 40 may have a configuration similar to that of the ground station 20 or may have a configuration similar to that of the non-ground station 30.

The relay station 40 of the present embodiment is, for example, a layer 3 relay, and is different from a conventional layer 1 relay that only amplifies power of a reception RF signal. Here, the layer 3 relay is a relay that can decode up to the layer 3. Note that the relay station 40 may be a smart repeater. Unlike a conventional layer 1 relay, the smart repeater is a relay capable of controlling a physical layer (PHY) or the like. In addition, descriptions of the relay stations appearing in the following description can be replaced with other descriptions indicating the relay station such as a relay and a relay device.

Note that the relay station 40 may be a fixed device or a movable device. At this time, the relay station 40 may be a floatable device. In addition, the size of the coverage of the relay station 40 is not limited to a specific size. For example, the cell covered by the relay station 40 may be a macrocell, a microcell, or a small cell. Of course, the coverage of the relay station 40 may be extremely small, such as the femtocell. In addition, the relay station 40 may have a beamforming capability. In this case, the relay station 40 may form a cell or a service area for each beam.

In addition, the relay station 40 is not limited to a mounted device as long as the function of relay is satisfied. For example, the relay station 40 may be mounted on the terminal device such as a smartphone, may be mounted on a vehicle such as an automobile, a train, or a human-powered vehicle, may be mounted on a flying body (floating body) such as a balloon, an airplane, or a drone, may be mounted on equipment such as a traffic light, a sign, or a street light, or may be mounted on a home appliance such as a television, a game machine, an air conditioner, a refrigerator, or a lighting fixture. In addition, the relay station may be provided on an outer wall of an architecture (for example, building). By providing the relay station on the outer wall of the building, even when there is a shield between the base station and the terminal device, a signal from the base station can be transferred by the relay station provided on the outer wall of the building and reach the terminal device.

In addition, similarly to the base station described above, the relay station 40 may be a device installed in a mobile body or may be a mobile body itself. As described above, the mobile body may be a mobile terminal such as a smartphone or a mobile phone. In addition, the mobile body may be a mobile body that moves on land (on the ground in a narrow sense) or may be a mobile body that moves in the ground. Of course, the mobile body may be a mobile body that moves over water or may be a mobile body that moves under water. In addition, the mobile body may be a mobile body that moves inside the atmosphere or may be a mobile body that moves outside the atmosphere. In addition, the relay station 40 may be a ground station device or a non-ground station device. At this time, the relay station 40 may be the aircraft station or the satellite station.

In addition, the relay station 40 may be an aviation station or an earth station. The aviation station is a wireless station installed on the ground or in a mobile body moving on the ground in order to communicate with the aircraft station. In addition, the earth station is a wireless station located on the earth (including in the air) in order to communicate with the satellite station (space station). The earth station may be a large earth station or a small earth station such as a very small aperture terminal (VSAT).

Note that the earth station may be a VSAT controlled earth station (It is also referred to as a master station or a HUB station.) or a VSAT earth station (It is also referred to as a slave station.). In addition, the earth station may be a wireless station installed in the mobile body moving on the ground. Examples of the earth stations mounted on a ship includes earth stations on board vessels (ESV). In addition, the earth station may include an aircraft earth station that is installed in an aircraft (including a helicopter) and communicates with the satellite station. In addition, the earth station may include an aviation earth station that is installed in the mobile body moving on the ground and communicates with the aircraft earth station via the satellite station.

Note that the relay station 40 may be a portable and movable wireless station that communicates with the satellite station or the aircraft station.

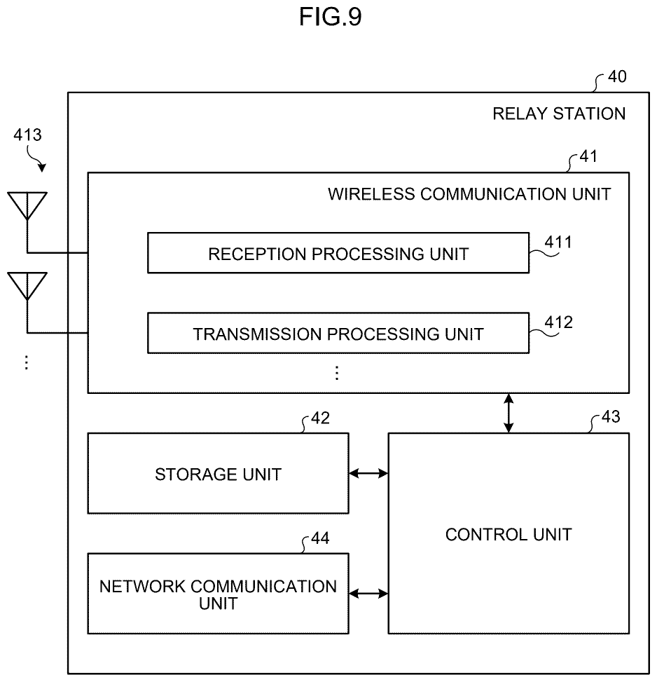

FIG. 9 is a diagram illustrating a configuration example of the relay station 40 according to an embodiment of the present disclosure. The relay station 40 includes a wireless communication unit 41, a storage unit 42, the control unit 43, and a network communication unit 44. The relay station 40 may also include a sensor unit. Note that the configuration illustrated in FIG. 9 is a functional configuration, and the hardware configuration may be different from the functional configuration. In addition, the functions of the relay station 40 may be implemented by being dispersed into the plurality of physically separated configurations.

The wireless communication unit 41 is a signal processing unit for wirelessly communicating with other wireless communication devices (for example, the ground station 20, the non-ground station 30, the relay station 40, the terminal device 50, and another relay station 40). The wireless communication unit 41 operates under the control of the control unit 43. The wireless communication unit 41 includes a reception processing unit 411, a transmission processing unit 412, and an antenna 413. The configurations of the wireless communication unit 41, the reception processing unit 411, the transmission processing unit 412, and the antenna 413 may be similar to those of the wireless communication unit 21, the reception processing unit 211, the transmission processing unit 212, and the antenna 213 of the ground station 20. In addition, the wireless communication unit 41 may be configured to be beam-formable similarly to the wireless communication unit 21. At this time, the wireless communication unit 41 may be configured to be polarization beam-formable similarly to the wireless communication unit 21. In addition, similarly to the wireless communication unit 21, the wireless communication unit 41 may be configured to be able to transmit and receive spatially multiplexed signals.

The storage unit 42 is a storage device capable of reading and writing data, such as the DRAM, the SRAM, the flash memory, or the hard disk. The storage unit 42 functions as a means of storage of the relay station 40.

The control unit 43 is a controller that controls each unit of the relay station 40. The control unit 43 is realized by, for example, a processor such as the CPU, the MPU, or the GPU. For example, the control unit 43 is realized by the processor executing various programs stored in a storage device inside the relay station 40 using the RAM or the like as a work area. Note that the control unit 43 may be realized by the integrated circuit such as the ASIC or the FPGA. In addition, the control unit 43 may be realized by the GPU. Any of the CPU, the MPU, the ASIC, the FPGA, and the GPU can be regarded as a controller. Note that the control unit 43 may include a plurality of physically separated objects. For example, the control unit 43 may include a plurality of semiconductor chips.

Note that the operation of the control unit 43 of the relay station 40 may be similar to the operation of the control unit 23 of the ground station 20 or the control unit 33 of the non-ground station 30. Conversely, the operation of the control unit 23 of the ground station 20 or the control unit 33 of the non-ground station 30 may be similar to the operation of the control unit 43 of the relay station 40. In addition, the operation of the control unit 43 may be similar to the operation of the control unit 13 of the management device 10, or may be similar to the operation of the control unit 53 of the terminal device 50.

The network communication unit 44 is a communication interface for communicating with other devices. The network communication unit 44 is, for example, a network interface. For example, the network communication unit 44 is the LAN interface such as the NIC. Note that the network communication unit 44 may be a wired interface or a wireless interface. The network communication unit 44 functions as a means of communication of the relay station 40. The network communication unit 44 communicates with the management device 10, the ground station 20, and the like under the control of the control unit 43.

Note that the relay station 40 may include a sensor unit similarly to the non-ground station 30. In this case, the sensor unit included in the relay station 40 may have a configuration similar to that of the sensor unit 34 of the non-ground station 30.

### 2-7. Configuration Example of Terminal Device

Next, a configuration of the terminal device 50 will be described.

The terminal device 50 is a wireless communication device that wirelessly communicates with other communication devices such as the ground station 20 and the non-ground station 30. Any form of computer can be employed as the terminal device 50. It may be a mobile terminal such as a mobile phone, a smart device (smartphone or tablet), a personal digital assistant (PDA), or a notebook PC. In addition, the terminal device 50 may be a game machine having a communication function. In addition, the terminal device 50 may be an imaging device (for example, a camcorder) having a communication function. In addition, the terminal device 50 may be a motorcycle, a moving relay vehicle, or the like on which a communication device such as a field pickup unit (FPU) is mounted. In addition, the terminal device 50 may be a machine to machine (M2M) device or an Internet of Things (IoT) device. In addition, the terminal device 50 may be a wearable device such as a smart watch.

Note that the terminal device 50 may be an xR device such as an augmented reality (AR) device, a virtual reality (VR) device, or a mixed reality (MR) device. At this time, the xR device may be a glasses-type device such as AR glasses or MR glasses, or may be a head-mounted device such as a VR head-mounted display. In a case where the terminal device 50 is the xR device, the terminal device 50 may be a standalone device including only a user wearing portion (for example, the glasses portion). In addition, the terminal device 50 may be a terminal interlocking device including the user wearing portion (for example, the glasses portion) and a terminal portion (for example, a smart device) interlocked with the portion.

Note that the terminal device 50 may be configured to be connectable to a plurality of communication paths. For example, the terminal device 50 may be configured to be connectable to two communication paths of Wi-Fi (registered trademark) and a cellular network. In addition, the terminal device 50 may be connectable to a plurality of cellular networks. At this time, the plurality of cellular networks may include a first cellular network including a terrestrial network and a second cellular network including a non-terrestrial network. At this time, the plurality of cellular networks may be associated with different subscriber identity modules (SIMs).

Note that the terminal device 50 may be configured to be able to switch and use a plurality of SIM cards. For example, the terminal device 50 may be compatible with dual SIM or triple SIM. Of course, the terminal device 50 may be configured to be able to insert more than three SIM cards. In addition, the terminal device 50 may be compatible with remote SIM provisioning (RSP). For example, the terminal device 50 may be compatible with an embedded SIM (eSIM). The RSP-compatible terminal device can rewrite information (hereinafter, referred to as a profile) related to wireless communication without replacing the SIM card.

Note that the terminal device 50 may be able to perform NOMA communication with the ground station 20. In addition, the terminal device 50 may be able to use an automatic retransmission technology such as the HARQ when communicating with the ground station 20. The terminal device 50 may be able to perform sidelink communication with another terminal device 50. Also, when performing sidelink communication, the terminal device 50 may be able to use the automatic retransmission technology such as the HARQ. Note that the terminal device 50 may also be able to perform NOMA communication in communication (sidelink) with another terminal device 50. In addition, the terminal device 50 may be able to perform LPWA communication with other communication devices (for example, the ground station 20 and another terminal device 50). In addition, the wireless communication used by the terminal device 50 may be wireless communication using millimeter waves. Note that the wireless communication (including sidelink communication) used by the terminal device 50 may be wireless communication using radio waves or wireless communication (optical wireless) using infrared rays or visible light.

In addition, the terminal device 50 may be a mobile device (mobile station). The mobile device is a mobile wireless communication device. At this time, the terminal device 50 may be a wireless communication device installed in a mobile body or may be a mobile body itself. For example, the terminal device 50 may be a vehicle that moves on a road such as an automobile, a bus, a truck, or a motorcycle, a vehicle that moves on a rail installed on a track of a train or the like, or a wireless communication device mounted on the vehicle. Note that the mobile body may be a mobile terminal such as a smartphone. In addition, the mobile body may be a mobile body that moves on land (on the ground in a narrow sense), in the ground, over water, or under water. In addition, the mobile body may be a mobile body that moves inside the atmosphere, such as an aircraft, an airship, a balloon, or a helicopter, or may be a mobile body that moves outside the atmosphere, such as an artificial satellite. The mobile body may be the unmanned aerial vehicle (UAV) such as a drone. In addition, the terminal device 50 may be a wireless communication device mounted on a mobile body moving inside the atmosphere such as an aircraft, an airship, a balloon, or a helicopter, a mobile body moving outside the atmosphere such as an artificial satellite, or a mobile body such as the unmanned aerial vehicle (UAV) such as a drone.

The terminal device 50 may be connected to and communicate with the plurality of base stations or the plurality of cells at the same time. For example, in a case where one base station supports a communication area via the plurality of cells (for example, pCell, sCell), the base station and the terminal device 50 may communicate by bundling the plurality of cells by a carrier aggregation (CA) technology, a dual connectivity (DC) technology, and/or a multi-connectivity (MC) technology. Alternatively, the terminal device 50 and the plurality of base stations may communicate with each other via cells of different base stations by a coordinated multi-point transmission and reception (COMP) technology.

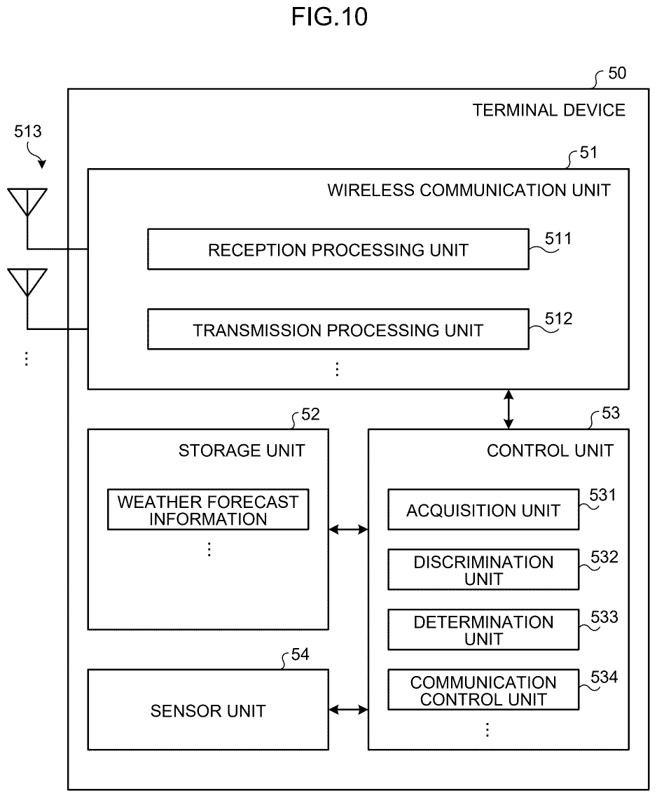

FIG. 10 is a diagram illustrating a configuration example of the terminal device 50 according to an embodiment of the present disclosure. The terminal device 50 includes a wireless communication unit 51, a storage unit 52, the control unit 53, and the sensor unit 54. Note that the configuration illustrated in FIG. 10 is a functional configuration, and the hardware configuration may be different from the functional configuration. In addition, the functions of the terminal device 50 may be implemented by being dispersed into the plurality of physically separated configurations.

The wireless communication unit 51 is a signal processing unit for wirelessly communicating with other wireless communication devices (for example, the ground station 20, the non-ground station 30, the relay station 40, and another terminal device 50). The wireless communication unit 51 operates under the control of the control unit 53. The wireless communication unit 51 includes a reception processing unit 511, a transmission processing unit 512, and an antenna 513. The configurations of the wireless communication unit 51, the reception processing unit 511, the transmission processing unit 512, and the antenna 513 may be similar to those of the wireless communication unit 21, the reception processing unit 211, the transmission processing unit 212, and the antenna 213 of the ground station 20. In addition, the wireless communication unit 51 may be configured to be beam-formable similarly to the wireless communication unit 21. At this time, the wireless communication unit 51 may be configured to be polarization beam-formable similarly to the wireless communication unit 21. In addition, similarly to the wireless communication unit 21, the wireless communication unit 51 may be configured to be able to transmit and receive spatially multiplexed signals.

The storage unit 52 is a storage device capable of reading and writing data, such as the DRAM, the SRAM, the flash memory, or the hard disk. The storage unit 52 functions as a means of storage of the terminal device 50.

The control unit 53 is a controller that controls each unit of the terminal device 50. The control unit 53 is realized by, for example, a processor such as the CPU, the MPU, or the GPU. For example, the control unit 53 is realized by the processor executing various programs stored in a storage device inside the terminal device 50 using the RAM or the like as a work area. Note that the control unit 53 may be realized by the integrated circuit such as the ASIC or the FPGA. In addition, the control unit 53 may be realized by the GPU. Any of the CPU, the MPU, the ASIC, the FPGA, and the GPU can be regarded as a controller. Note that the control unit 53 may include a plurality of physically separated objects. For example, the control unit 53 may include a plurality of semiconductor chips.

The control unit 53 includes an acquisition unit 531, a discrimination unit 532, a determination unit 533, and a communication control unit 534. Each block (the acquisition unit 531 to the communication control unit 534) constituting the control unit 53 is a functional block indicating a function of the control unit 53. These functional blocks may be software blocks or hardware blocks. For example, each of the above-described functional blocks may be one software module realized by software (including microprogram), or may be one circuit block on a semiconductor chip (die). Of course, each functional block may be one processor or one integrated circuit. The control unit 53 may be configured by a functional unit different from the above-described functional block. A configuration method of the functional block is arbitrary. The operation of each functional block will be described later.

Note that the operations of the blocks (the acquisition unit 531 to the communication control unit 534) constituting the control unit 53 may be similar to the operations of (the acquisition unit 331 to the communication control unit 334) included in the control unit 33 of the non-ground station 30. In addition, the operation of the control unit 53 may be similar to the operation of the control unit 13 of the management device 10, may be similar to the operation of the control unit 23 of the ground station 20, or may be similar to the operation of the control unit 43 of the relay station 40.

The sensor unit 54 includes one or more of sensors that perform measurement related to weather. The sensor unit 54 may include, for example, a rain-sensitive sensor, a humidity sensor (hygrometer), or a temperature sensor (thermometer). In addition, the sensor unit 54 may include an atmospheric pressure sensor (barometer). In addition, the sensor unit 54 may include a visible sensor (image sensor) that captures visible light. In addition, the sensor unit 54 may include an infrared sensor or a mid-infrared sensor.

In addition, the sensor unit 54 may include a sensor that acquires information regarding the position, moving speed, or moving direction of the terminal device 50. For example, the sensor unit 54 may include a global navigation satellite system (GNSS) sensor. Here, the GNSS sensor may be a global positioning system (GPS) sensor, a GLONASS sensor, a Galileo sensor, or a quasi-zenith satellite system (QZSS) sensor. The GNSS sensor can be rephrased as a GNSS receiving module. In addition, the sensor unit 54 may include an acceleration sensor. In addition, the sensor unit 54 may include an inertial measurement unit (IMU), a geomagnetic sensor, or an altimeter.

In addition, the sensor unit 54 may include a sensor that measures a situation around the terminal device 50. For example, the sensor unit 54 may include a depth sensor such as light detection and ranging (LiDAR). Of course, the sensor unit 54 may include a depth sensor other than the LiDAR. In addition, the sensor unit 54 may include a distance measuring system using a millimeter wave radar. In addition, the sensor unit 54 may include a time of flight (ToF) sensor or may include a stereo camera.

In addition, the sensor unit 54 may include a sensor for supplementing the position of the non-ground station 30. In addition, the sensor included in the sensor unit 54 may be a combination of a plurality of sensors. In addition, the sensor unit 54 may include a sensor similar to the sensor included in the sensor unit 34 of the non-ground station 30.

### 3. Operation of Communication System

The configuration of the communication system 1 has been described above. Next, the operation of the communication system 1 will be described in detail.

### 3-1. Outline of Processing

A radio wave is susceptible to weather. Therefore, the communication performance of the non-terrestrial network may decrease depending on the weather. For example, it is assumed that the weather near the non-ground station 30 and the terminal device 50 on the ground connected to the non-ground station 30 is rainy. In this case, the communication path between the non-ground station 30 and the terminal device 50 is a path that has passed a long distance through a section where rain and/or rain clouds exist (hereinafter, it is referred to as a rain zone.). Therefore, in such weather, when radio waves in a high frequency band are used for connection between the non-ground station 30 and the terminal device 50, the stability of connection between the non-ground station 30 and the terminal device 50 is deteriorated.

In the present embodiment, the solution is roughly divided into two means of a first means and a second means described below on the basis of the difference in a weather information acquisition method. Note that the following solution is merely an example, and the solution is not limited to the following two.

### (1) First Solution

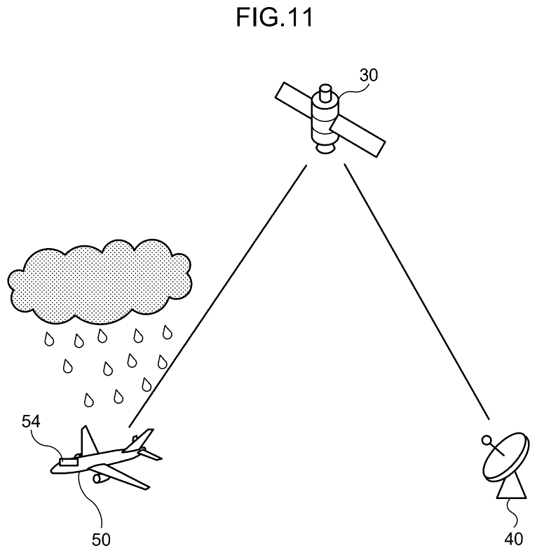

FIG. 11 is a diagram for describing an outline of a first solution. In the first solution, the terminal device 50 acquires weather information on the basis of information from the sensor unit 54 included in the terminal device 50. The sensor unit 54 includes, for example, at least one of a rain-sensitive sensor, a humidity sensor, and a temperature sensor. Then, the terminal device 50 makes a determination related to wireless communication with the non-ground station 30 on the basis of the weather information. For example, in a case where the weather information indicates a predetermined state (for example, rain), the terminal device 50 determines a wireless resource (hereinafter, it is simply referred to as a resource.) of a frequency band satisfying a predetermined criterion as a resource to be used for wireless communication with the non-ground station 30. For example, in a case where the weather information indicates a predetermined state (for example, rain), the terminal device 50 determines a resource of the lowest frequency band among a plurality of resources having different frequency bands as a resource to be used for wireless communication with the non-ground station 30. Then, the terminal device 50 is connected to at least one of the one or more non-ground stations 30 on the basis of the determination.

### (2) Second Solution

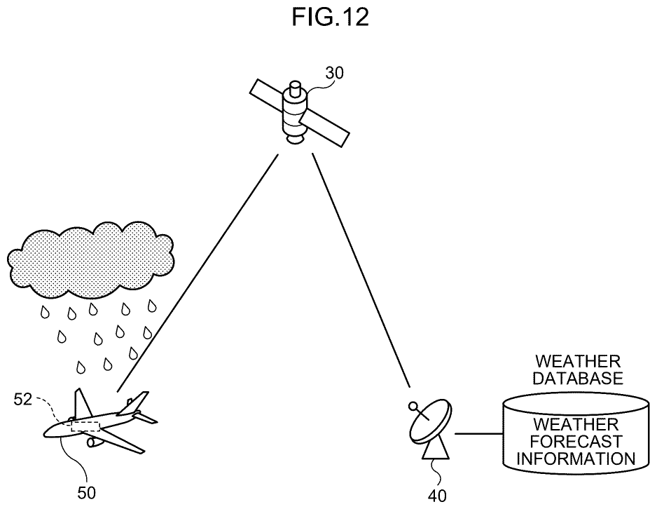

FIG. 12 is a diagram for describing an outline of a second solution. In the second solution, the terminal device 50 acquires weather information on the basis of weather forecast information stored in the storage unit 52. Then, the terminal device 50 makes a determination related to wireless communication with the non-ground station 30 on the basis of the weather information. For example, in a case where the weather information indicates a predetermined state (for example, rain), the terminal device 50 determines a resource (for example, a resource of a low frequency band) of a frequency band satisfying a predetermined criterion as a resource to be used for wireless communication with the non-ground station 30. Then, the terminal device 50 is connected to at least one of the one or more non-ground stations 30 on the basis of the determination.

The second solution is further roughly divided into two cases A and B described below on the basis of the difference in a weather forecast information updating method.

### (A) Case A

In case A, the terminal device 50 makes a determination related to wireless communication with the non-ground station 30 on the basis of the weather information acquired on the basis of the weather forecast information stored in advance in the storage unit 52. Then, the terminal device 50 is connected to the non-ground station 30 on the basis of the determination. After the connection, the terminal device 50 updates the weather forecast information from weather database, and perform reconnection to the non-ground station 30 as necessary.

### (B) Case B

In case B, in a case where the age of the weather forecast information stored in advance in the storage unit 52 satisfies a predetermined criterion, the terminal device 50 is connected to the non-ground station 30 on the basis of a predetermined setting (normal setting) before making a determination related to wireless communication with the non-ground station 30. After the connection, the terminal device 50 updates the weather forecast information from the weather database. Then, the terminal device 50 makes a determination related to wireless communication with the non-ground station 30 on the basis of the weather information acquired on the basis of the updated weather forecast information. Then, the terminal device 50 performs reconnection to the non-ground station 30 as necessary.

Although the outline of the processing of the communication system 1 has been described above, the operation of the communication system 1 will be described in detail below. Note that, in the following description, the first solution is referred to as a first embodiment, the case A of the second solution is referred to as a second embodiment, and the case B of the second solution is referred to as a third embodiment.

### 3-2. First Embodiment

First, a first embodiment will be described.

As described above, the first embodiment corresponds to the above-described first solution (FIG. 11). In the first embodiment, the terminal device 50 acquires weather information on the basis of information from a sensor included in the terminal device 50.

Note that, in the following description, it is assumed that the base station connected to the terminal device 50 is the non-ground station 30. Then, it is assumed that a resource of a frequency band F1 and a resource of a frequency band F2 can be selected when the terminal device 50 is connected to the non-ground station 30. Here, the frequency band F1 is a frequency band higher than the frequency band F2.

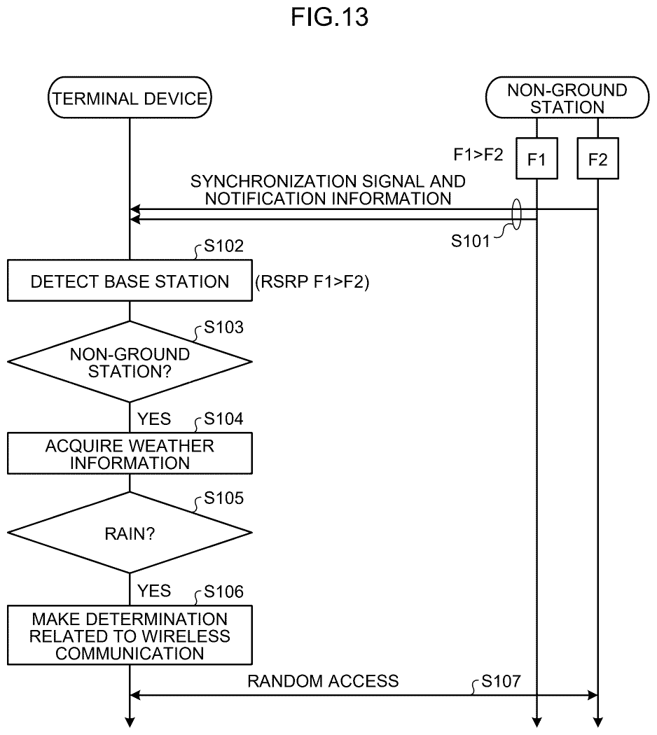

FIG. 13 is a diagram illustrating a sequence example of communication processing according to the first embodiment. The communication processing illustrated in FIG. 13 is executed by the control unit 33 of the non-ground station 30 and the control unit 53 of the terminal device 50. Hereinafter, the communication processing of the first embodiment will be described with reference to a sequence diagram of FIG. 13.

First, the base station (the ground station 20 and/or the non-ground station 30) transmits various signals/information to the surroundings. It is assumed that the base station is the non-ground station 30. In this case, the non-ground station 30 transmits, for example, a synchronization signal and notification information toward the ground (step S101).

Then, the communication control unit 534 of the terminal device 50 detects the base station (step S102). For example, the communication control unit 534 performs a cell search on the basis of the signals/information from the base station. The cell search is a procedure for user equipment (UE) to detect a physical cell ID (PCI) of a cell and obtain time and frequency synchronization. The cell search of the present embodiment includes, for example, detection of a synchronization signal and a process of decoding a physical broadcast channel (PBCH). The communication control unit 534 performs synchronization between the downlink and the cell on the basis of the detected synchronization signal. Then, after establishment of downlink synchronization, the communication control unit 534 acquires system information by, for example, decoding a physical channel such as the PBCH.

The system information is information for notifying setting in the cell to which the system information is transmitted. The system information includes, for example, information regarding access to a cell, information regarding cell selection, and information regarding other radio access technology (RAT) or other systems. The system information includes, for example, a master information block (MIB) and a system information block (SIB). The MIB is physical layer information necessary for receiving the SIB and the like, and is notified by, for example, the PBCH. The SIB is system information other than the MIB, and is notified by, for example, a physical downlink shared channel (PDSCH).

Note that, in the following description, it is assumed that the terminal device 50 has detected the non-ground station 30. Then, it is assumed that a resource of a frequency band Fl and a resource of a frequency band F2 can be selected when the terminal device 50 is connected to the non-ground station 30. As described above, the frequency band F1 is a frequency band higher than the frequency band F2.

In addition, for the terminal device 50, it is assumed that the resource of the frequency band F1 has higher reception quality than the resource of the frequency band F2. Here, the reception quality is, for example, reference signal received power (RSRP). Note that the reception quality is not limited to the RSRP, and may be, for example, reference signal received quality (RSRQ), received signal strength indicator (RSSI), or signal to interference plus noise ratio (SINR). In addition, the reception quality may be a combination of the plurality of indices.

Note that the terminal device 50 may acquire information on the peripheral cell in steps S101 and S102. At this time, the terminal device 50 may acquire the information on the peripheral cell from the cell detected first (the base station from which the system information is acquired first). Alternatively, the terminal device 50 may also detect other cells and acquire information on the peripheral cells from the detected cells.

Subsequently, the discrimination unit 532 of the terminal device 50 discriminates whether or not the detected base station is a non-ground station (step S103). At this time, the discrimination unit 532 may discriminate whether or not the detected base station is a non-ground station on the basis of system information (for example, ntn-Config of SIB19).

Note that the discrimination unit 532 of the terminal device 50 may discriminate details of the detected base station in addition to whether or not the detected base station is a non-ground station. For example, if the detected base station is a non-ground station, the terminal device 50 may discriminate the altitude of the detected base station. For example, if the detected base station is a satellite station, the terminal device 50 may discriminate the altitude of the detected base station.

In addition, if the detected base station is a non-ground station, the discrimination unit 532 of the terminal device 50 may discriminate which type of non-ground station the detected base station is. For example, the discrimination unit 532 may discriminate which of a plurality of types of non-ground stations including at least one of the HAPS, the LEO, the MEO, the GEO, and the HEO the detected base station corresponds to. Of course, the discrimination unit 532 may discriminate whether or not the detected base station is a satellite station, or may discriminate whether or not the detected base station is the HAPS. In addition, if the detected base station is a satellite station, the discrimination unit 532 may discriminate which type of satellite station the detected base station is. For example, the discrimination unit 532 may discriminate which of a plurality of types of satellite stations including at least one of the LEO, the MEO, the GEO, and the HEO the detected base station corresponds to.

Note that the discrimination unit 532 of the terminal device 50 may discriminate details (for example, the type of the non-base station and the altitude of the non-ground station) of the detected base station on the basis of information/signals from the base station (non-ground station 30). For example, the discrimination unit 532 may discriminate the type and/or altitude of the above-described non-ground station on the basis of the value of the timing advance.

As described above, in the present sequence example, it is assumed that the base station detected by the terminal device 50 is a non-ground station. Note that, in a case where the base station detected by the terminal device 50 is not a non-ground station (that is, in the case of a ground station), the terminal device 50 may be connected to the base station according to a conventional connection procedure.

If the base station detected by the terminal device 50 is a non-ground station (step S103: Yes), the acquisition unit 531 of the terminal device 50 acquires weather information on the basis of information from the sensor unit 54 included in the terminal device 50 (step S104). The sensor unit 54 includes one or more of sensors that can perform measurement related to weather. For example, the sensor unit 54 includes at least one of a rain-sensitive sensor, a humidity sensor (hygrometer), and a temperature sensor (thermometer). The acquisition unit 531 may estimate the current weather on the basis of the information from the sensor unit 54 to acquire the estimation result as the weather information. In addition, the acquisition unit 531 may acquire the information from the sensor unit 54 as it is as the weather information.

Then, the determination unit 533 of the terminal device 50 makes a determination related to wireless communication with the non-ground station 30 on the basis of the weather information (steps S105 and S106). More specifically, the determination unit 533 discriminates whether or not a range affecting wireless communication between the terminal device 50 and the non-ground station 30 indicates a predetermined state on the basis of the weather information. For example, the determination unit 533 discriminates whether or not the weather around the terminal device 50 is in a predetermined state (for example, rain) on the basis of the weather information (step S105). Note that the predetermined state is typically rain, but is not limited to rain. For example, the predetermined state may be snow, fog, or cloudy.

Then, in a case where the weather information indicates a predetermined state (for example, rain) (step S105: Yes), the determination unit 533 of the terminal device 50 determines the resource of the frequency band satisfying the predetermined criterion as the resource used for wireless communication between the terminal device 50 and the non-ground station 30 (step S106).

For example, in a case where the weather information indicates a predetermined state, the determination unit 533 determines a resource of the lowest frequency band among a plurality of resources having different frequency bands as the resource to be used for wireless communication between the terminal device 50 and the non-ground station 30. For example, it is assumed that the terminal device 50 can use the resource of the frequency band F1 and the resource of the frequency band F2 for connection with the non-ground station 30. If the frequency band F2 is a frequency band lower than the frequency band F1, the determination unit 533 determines the resource of the frequency band F2 as the resource to be used for wireless communication between the terminal device 50 and the non-ground station 30. In addition, the determination unit 533 of the terminal device 50 may determine a resource of a frequency band lower than a predetermined value as a resource to be used for wireless communication. Note that the determination unit 533 of the terminal device 50 may consider information on reception quality such as the RSRP when determining the resource to be used for wireless communication between the terminal device 50 and the non-ground station 30. For example, in a case where the difference in the value of the RSRP between the frequency bands is larger than a predetermined reference value, the resource to be used for wireless communication between the terminal device 50 and the non-ground station 30 may be determined on the basis of a conventional selection criterion.

Note that, in a case where the weather is not in the predetermined state, the determination unit 533 of the terminal device 50 may determine the resource to be used for wireless communication between the terminal device 50 and the non-ground station 30 on the basis of the conventional selection criterion. For example, the determination unit 533 may determine a resource having the highest reception quality among the plurality of frequency resources as the resource to be used for wireless communication.

Then, the communication control unit 534 of the terminal device 50 is connected to the non-ground station 30 by executing a random access procedure (step S107). At this time, the communication control unit 534 is connected to the non-ground station 30 on the basis of the determination in step S106. For example, the communication control unit 534 is connected to the non-ground station 30 by using the resource of the frequency band determined in step S106.

According to the first embodiment, since the terminal device 50 discriminates the weather by using the sensor provided therein, it is possible to discriminate the weather accurately and in real time. Therefore, the terminal device 50 can determine the resource to be used for communication on the basis of accurate and real-time weather information at the time of performing communication. As a result, the terminal device 50 can enhance the stability of the connection with the non-ground station 30 even in bad weather.

In addition, since the terminal device 50 discriminates the weather by using the sensor included therein, it is not necessary to refer to a weather database on the network or to perform processing of estimating a weather condition. In addition, since the terminal device 50 discriminates the weather by using the sensor included therein, the processing is performed faster. As a result, optimization/maximization of the communication capacity is realized. In addition, since the terminal device 50 discriminates the weather by using the sensor included therein, a mechanism for exchanging data with the network becomes unnecessary. As a result, the weather determination system can be simplified.

### 3-3. Second Embodiment

Next, a second embodiment will be described.

As described above, the second embodiment corresponds to case A of the above-described second solution (FIG. 12). In the second embodiment, the terminal device 50 makes a determination related to wireless communication with the non-ground station 30 on the basis of weather information acquired on the basis of the weather forecast information stored in advance in the storage unit 52. Then, the terminal device 50 is connected to the non-ground station 30 on the basis of the determination. After the connection, the terminal device 50 updates the weather forecast information from weather database, and perform reconnection to the non-ground station 30 as necessary.

Note that, in the second embodiment, similarly to the first embodiment, it is assumed that the base station connected to the terminal device 50 is the non-ground station 30. Then, it is assumed that a resource of a frequency band F1 and a resource of a frequency band F2 can be selected when the terminal device 50 is connected to the non-ground station 30. Here, the frequency band Fl is a frequency band higher than the frequency band F2.

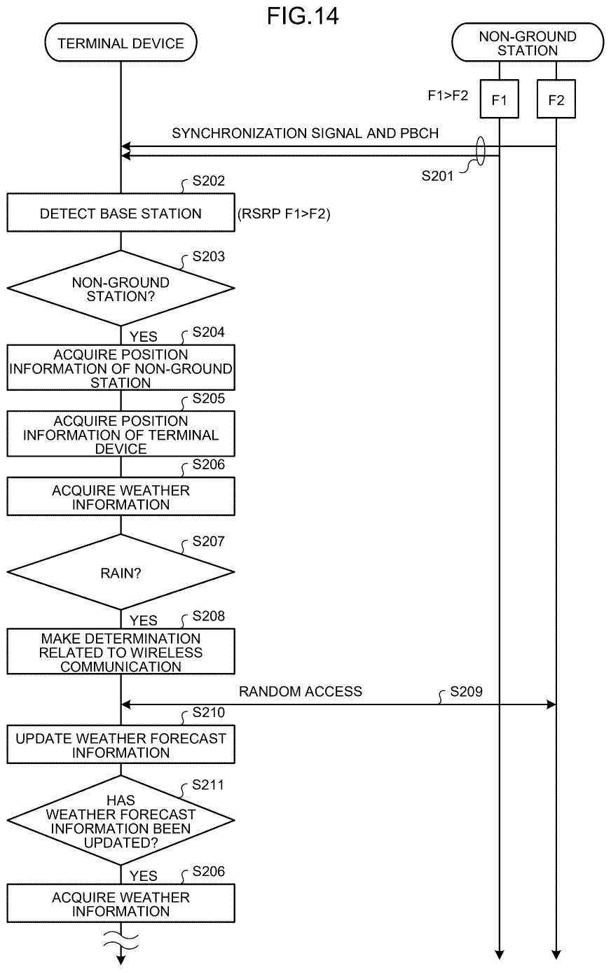

FIG. 14 is a diagram illustrating a sequence example of communication processing according to the second embodiment. The communication processing illustrated in FIG. 14 is executed by the control unit 33 of the non-ground station 30 and the control unit 53 of the terminal device 50. Hereinafter, the communication processing of the second embodiment will be described with reference to a sequence diagram of FIG. 14.

First, the base station (the ground station 20 and/or the non-ground station 30) transmits various signals/information to the surroundings. It is assumed that the base station is the non-ground station 30. In this case, the non-ground station 30 transmits, for example, the synchronization signal and notification information toward the ground (step S201).

Then, the communication control unit 534 of the terminal device 50 detects the base station (step S202).

Note that, in the following description, it is assumed that the terminal device 50 has detected the non-ground station 30. Then, it is assumed that a resource of a frequency band F1 and a resource of a frequency band F2 can be selected when the terminal device 50 is connected to the non-ground station 30. As described above, the frequency band F1 is a frequency band higher than the frequency band F2. In addition, for the terminal device 50, it is assumed that the resource of the frequency band F1 has higher reception quality than the resource of the frequency band F2.

Note that the terminal device 50 may acquire information on the peripheral cell in steps S201 and S202. At this time, the terminal device 50 may acquire the information on the peripheral cell from the cell detected first (the base station from which the system information is acquired first). Alternatively, the terminal device 50 may also detect other cells and acquire information on the peripheral cells from the detected cells. In addition, steps S201 and S202 may be similar to steps S101 and S102 of the first embodiment.

Subsequently, the discrimination unit 532 of the terminal device 50 discriminates whether or not the detected base station is a non-ground station (step S203). At this time, the discrimination unit 532 may discriminate whether or not the detected base station is a non-ground station on the basis of system information (for example, ntn-Config of SIB19). Note that the discrimination unit 532 of the terminal device 50 may discriminate details of the detected base station (for example, the type of the non-base station and the altitude of the non-ground station) in addition to whether or not the detected base station is a non-ground station. At this time, the discrimination unit 532 may discriminate the type and/or altitude of the non-ground station on the basis of the value of the timing advance. In addition, step S203 may be similar to step S103 of the first embodiment.

As described above, in the present sequence example, it is assumed that the base station detected by the terminal device 50 is a non-ground station. Note that, in a case where the base station detected by the terminal device 50 is not a non-ground station (that is, in the case of a ground station), the terminal device 50 may be connected to the base station according to a conventional connection procedure.

In a case where the base station detected by the terminal device 50 is a non-ground station (step S203: Yes), the acquisition unit 531 of the terminal device 50 acquires the position information of the non-ground station 30 (step S204). At this time, the acquisition unit 531 may acquire the position information of the non-ground station 30 on the basis of the system information from the non-ground station 30. For example, the acquisition unit 531 may specify the position (for example, the current position of the satellite) of the non-ground station 30 on the basis of the ntn-Config of the SIB19.

Subsequently, the acquisition unit 531 of the terminal device 50 acquires the position information of the terminal device 50 (step S205). At this time, the acquisition unit 531 may acquire the position information of the terminal device 50 on the basis of the information from the sensor unit 54. For example, the acquisition unit 531 may specify the position information of the terminal device 50 on the basis of the information from the GNSS sensor.

Subsequently, the acquisition unit 531 of the terminal device 50 acquires weather information on the basis of the weather forecast information stored in advance in the storage unit 52 (step S206). At this time, the acquisition unit 531 may acquire weather information in a range affecting wireless communication as the weather information. For example, the acquisition unit 531 may acquire the weather information on the basis of the position information of the non-ground station 30, the position information of the terminal device 50, and the weather forecast information. For example, the acquisition unit 531 may specify a range that affects wireless communication on the basis of the position information of the non-ground station 30 and the position information of the terminal device 50, and acquire weather forecast information in the specified range as the weather information. Note that the acquisition unit 531 may acquire the weather forecast information stored in the storage unit 52 as it is as the weather information.

Then, the determination unit 533 of the terminal device 50 makes a determination related to wireless communication with the non-ground station 30 on the basis of the weather information (steps S207 and S208). More specifically, the determination unit 533 discriminates whether or not a range affecting wireless communication between the terminal device 50 and the non-ground station 30 indicates a predetermined state (for example, rain) on the basis of the weather information (step S207). Note that the predetermined state is typically rain, but is not limited to rain. For example, the predetermined state may be snow, fog, or cloudy.

Then, in a case where the weather information indicates a predetermined state (for example, rain) (step S207: Yes), the determination unit 533 of the terminal device 50 determines the resource of the frequency band satisfying the predetermined criterion as the resource used for wireless communication between the terminal device 50 and the non-ground station 30 (step S208). For example, in a case where the weather information indicates a predetermined state, the determination unit 533 determines a resource of the lowest frequency band among a plurality of resources as a resource to be used for wireless communication between the terminal device 50 and the non-ground station 30. In addition, in a case where the weather information indicates a predetermined state, the determination unit 533 may determine a resource of a frequency band lower than a predetermined value as a resource to be used for wireless communication. Note that the determination unit 533 of the terminal device 50 may consider information on reception quality such as the RSRP when determining the resource to be used for wireless communication between the terminal device 50 and the non-ground station 30. For example, in a case where the difference in the value of the RSRP between the frequency bands is larger than a predetermined reference value, the resource to be used for wireless communication between the terminal device 50 and the non-ground station 30 may be determined on the basis of a conventional selection criterion. In addition, step S208 may be similar to step S106 of the first embodiment.

Note that, in a case where the weather is not in the predetermined state, the determination unit 533 of the terminal device 50 may determine the resource to be used for wireless communication between the terminal device 50 and the non-ground station 30 on the basis of the conventional selection criterion. For example, the determination unit 533 may determine a resource having the highest reception quality among the plurality of resources as the resource to be used for the wireless communication.

Subsequently, the communication control unit 534 of the terminal device 50 is connected to the non-ground station 30 by executing the random access procedure (step S209). At this time, the communication control unit 534 is connected to the non-ground station 30 on the basis of the determination in step S208. For example, the communication control unit 534 is connected to the non-ground station 30 by using the resource of the frequency band determined in step S208.

After the connection, the acquisition unit 531 of the terminal device 50 performs processing related to update of weather forecast information (step S210). For example, the acquisition unit 531 accesses a weather database on the network PN via the non-ground station 30. Then, in a case where there is new information in the weather database, the acquisition unit 531 updates the weather forecast information.

Subsequently, the discrimination unit 532 of the terminal device 50 discriminates whether or not the weather forecast information has been updated (step S211). If the weather forecast information has been updated (step S211: Yes), the control unit 53 of the terminal device 50 repeats the processing of steps S206 to S209. Thereafter, the acquisition unit 531 performs processing related to the update of weather forecast information periodically or in accordance with a predetermined criterion (step S210). For example, the acquisition unit 531 may update the weather forecast information when it is approaching a time at which it starts to rain according to the weather forecast (for example, when the difference between the current time and the time when it starts to rain is equal to or less than a predetermined time). Subsequently, the discrimination unit 532 of the terminal device 50 discriminates whether or not the weather forecast information has been updated (step S211), and if the weather forecast information has been updated (step S211: Yes), the control unit 53 of the terminal device 50 may repeat the processing of steps S206 to S209.

That is, if the weather forecast information has been updated, the acquisition unit 531 of the terminal device 50 acquires the weather information on the basis of the updated weather forecast information (step S206). Then, the acquisition unit 531 of the terminal device 50 makes a determination related to wireless communication with the non-ground station 30 again on the basis of the new weather information (steps S207 and S208). If a determination that the current connection with the non-ground station 30 needs to be changed (for example, a determination different from the previous determination) is made, the communication control unit 534 of the terminal device 50 performs reconnection to the non-ground station 30 on the basis of the determination.

According to the second embodiment, the terminal device 50 determines the resource to be used for wireless communication on the basis of the weather forecast information stored in advance in the storage unit 52. Therefore, since it does not take time for network connection or the like to determine the resource, the terminal device 50 can quickly determine the resource to be used for wireless communication. As a result, the terminal device 50 can achieve high communication performance.

### 3-4. Third Embodiment

Next, a third embodiment will be described.

As described above, the third embodiment corresponds to case B of the above-described second solution (FIG. 12). In the third embodiment, in a case where the age of the weather forecast information stored in advance in the storage unit 52 satisfies a predetermined criterion, the terminal device 50 is connected to the non-ground station 30 on the basis of a predetermined setting (normal setting) before making a determination related to wireless communication with the non-ground station 30. After the connection, the terminal device 50 updates the weather forecast information from the weather database. Then, the terminal device 50 makes a determination related to wireless communication with the non-ground station 30 on the basis of the weather information acquired on the basis of the updated weather forecast information. Then, the terminal device 50 performs reconnection to the non-ground station 30 as necessary.

In the third embodiment, similarly to the first and second embodiments, it is assumed that the base station connected to the terminal device 50 is the non-ground station 30. Then, it is assumed that a resource of a frequency band F1 and a resource of a frequency band F2 can be selected when the terminal device 50 is connected to the non-ground station 30. Here, the frequency band Fl is a frequency band higher than the frequency band F2.

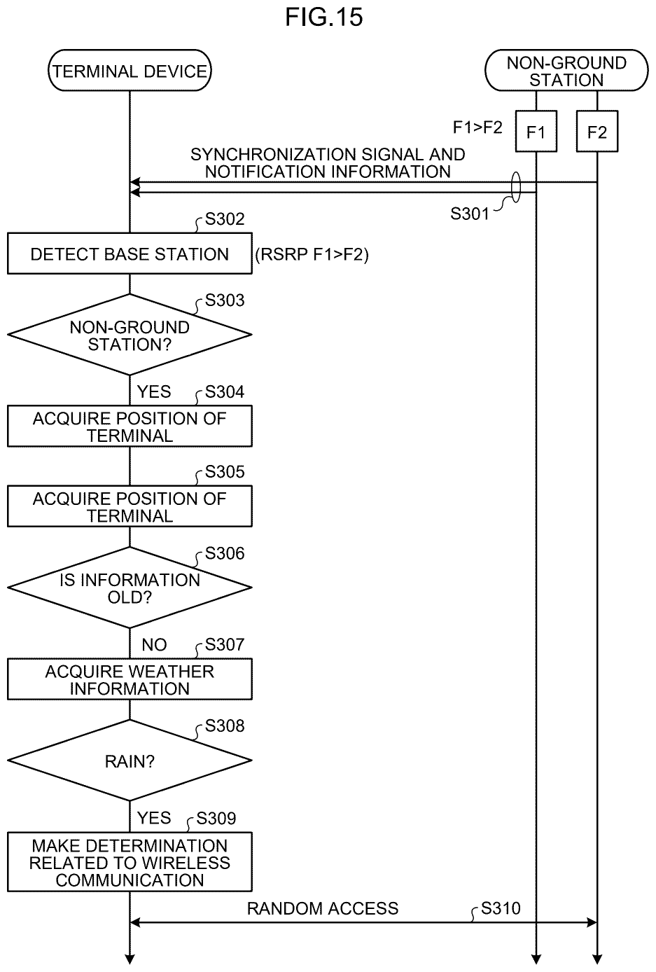

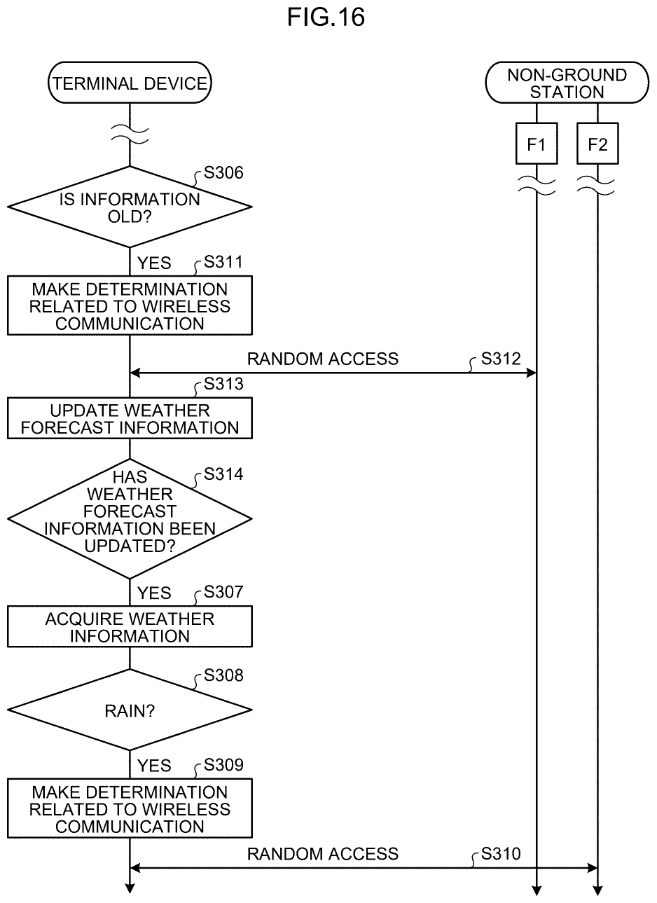

FIGS. 15 and 16 are diagrams illustrating a sequence example of communication processing according to the third embodiment. In the sequence example illustrated in FIG. 15 and the sequence example illustrated in FIG. 16, the processing after step S306 is different. The communication processing illustrated in FIGS. 15 and 16 is executed by the control unit 33 of the non-ground station 30 and the control unit 53 of the terminal device 50. Hereinafter, the communication processing of the third embodiment will be described with reference to the sequence diagrams of FIGS. 15 and 16.

First, the base station (the ground station 20 and/or the non-ground station 30) transmits various signals/information to the surroundings. It is assumed that the base station is the non-ground station 30. In this case, the non-ground station 30 transmits, for example, the synchronization signal and notification information toward the ground (step S301 of FIG. 15).

Then, the communication control unit 534 of the terminal device 50 detects the base station (step S302). Note that, in the following description, it is assumed that the terminal device 50 has detected the non-ground station 30. Then, it is assumed that a resource of a frequency band F1 and a resource of a frequency band F2 can be selected when the terminal device 50 is connected to the non-ground station 30. As described above, the frequency band F1 is a frequency band higher than the frequency band F2. In addition, for the terminal device 50, it is assumed that the resource of the frequency band F1 has higher reception quality than the resource of the frequency band F2.

Note that the terminal device 50 may acquire information on the peripheral cells in steps S301 and S302. At this time, the terminal device 50 may acquire the information on the peripheral cell from the cell detected first (the base station from which the system information is acquired first). Alternatively, the terminal device 50 may also detect other cells and acquire information on the peripheral cells from the detected cells. In addition, steps S301 and S302 may be similar to steps S101 and S102 of the first embodiment or steps S201 and S202 of the second embodiment.

Subsequently, the discrimination unit 532 of the terminal device 50 discriminates whether or not the detected base station is a non-ground station (step S303). At this time, the discrimination unit 532 may discriminate whether or not the detected base station is a non-ground station on the basis of system information (for example, ntn-Config of SIB19). Note that the discrimination unit 532 of the terminal device 50 may discriminate details of the detected base station (for example, the type of the non-base station and the altitude of the non-ground station) in addition to whether or not the detected base station is a non-ground station. At this time, the discrimination unit 532 may discriminate the type and/or altitude of the non-ground station on the basis of the value of the timing advance. In addition, step S303 may be similar to step S103 of the first embodiment or step S203 of the second embodiment.

As described above, in the present sequence example, it is assumed that the base station detected by the terminal device 50 is a non-ground station. Note that, in a case where the base station detected by the terminal device 50 is not a non-ground station (that is, in the case of a ground station), the terminal device 50 may be connected to the base station according to a conventional connection procedure.

In a case where the base station detected by the terminal device 50 is a non-ground station (step S303: Yes), the acquisition unit 531 of the terminal device 50 acquires the position information of the non-ground station 30 (step S304). Then, the acquisition unit 531 of the terminal device 50 acquires the position information of the terminal device 50 (step S305). In addition, steps S304 and S305 may be similar to steps S204 and S205 of the second embodiment.

Subsequently, the discrimination unit 532 of the terminal device 50 discriminates whether or not the age of the weather forecast information stored in the storage unit 52 satisfies a predetermined criterion (step S306). For example, the discrimination unit 532 discriminates whether the current date and time has passed a predetermined period from the last update of the weather forecast information.

If the weather forecast information is not old (step S306: No), the acquisition unit 531 of the terminal device 50 acquires the weather information on the basis of the weather forecast information stored in advance in the storage unit 52 (step S307). Step S307 may be similar to step S206 in the second embodiment.

Then, the determination unit 533 of the terminal device 50 makes a determination related to wireless communication with the non-ground station 30 on the basis of the weather information (steps S308 and S309). More specifically, the determination unit 533 discriminates whether or not a range affecting wireless communication between the terminal device 50 and the non-ground station 30 indicates a predetermined state (for example, rain) on the basis of the weather information (step S308). Note that the predetermined state is typically rain, but is not limited to rain. For example, the predetermined state may be snow, fog, or cloudy.

Then, in a case where the weather information indicates a predetermined state (for example, rain) (step S308: Yes), the determination unit 533 of the terminal device 50 determines the resource of the frequency band satisfying the predetermined criterion as the resource used for wireless communication between the terminal device 50 and the non-ground station 30 (step S309). Note that the determination unit 533 of the terminal device 50 may consider information on reception quality such as the RSRP when determining the resource to be used for wireless communication between the terminal device 50 and the non-ground station 30. For example, in a case where the difference in the value of the RSRP between the frequency bands is larger than a predetermined reference value, the resource to be used for wireless communication between the terminal device 50 and the non-ground station 30 may be determined on the basis of a conventional selection criterion. Step S309 may be similar to step S106 of the first embodiment or step S208 of the second embodiment. Note that, in a case where the weather is not in the predetermined state, the determination unit 533 of the terminal device 50 may determine the resource to be used for wireless communication between the terminal device 50 and the non-ground station 30 on the basis of the conventional selection criterion.

Subsequently, the communication control unit 534 of the terminal device 50 is connected to the non-ground station 30 by executing the random access procedure (step S310). At this time, the communication control unit 534 is connected to the non-ground station 30 on the basis of the determination in step S309. For example, the communication control unit 534 is connected to the non-ground station 30 by using the resource of the frequency band determined in step S309.

After the connection, the control unit 53 of the terminal device 50 may perform processing related to update of weather forecast information. Then, in a case where the weather forecast information has been updated, the acquisition unit 531 may acquire the weather information on the basis of the updated weather forecast information. Then, the determination unit 533 of the terminal device 50 may make a determination related to wireless communication with the non-ground station 30 again on the basis of new weather information. If a determination that the current connection with the non-ground station 30 needs to be changed (for example, a determination different from the previous determination) is made, the communication control unit 534 of the terminal device 50 may perform reconnection to the non-ground station 30 on the basis of the determination.

Referring to FIG. 16, if the weather forecast information is old (step S306: Yes), the determination unit 533 of the terminal device 50 determines the resource to be used for wireless communication between the terminal device 50 and the non-ground station 30 on the basis of a predetermined criterion (for example, conventional selection criterion) (step S311). For example, the determination unit 533 may determine a resource having the highest reception quality among the plurality of frequency resources as the resource to be used for wireless communication. The reception quality is, for example, the RSRP. Note that the reception quality is not limited to the RSRP, and may be, for example, the RSRQ, the RSSI, or the SINR. In addition, the reception quality may be a combination of the plurality of indices.

Subsequently, the communication control unit 534 of the terminal device 50 is connected to the non-ground station 30 by executing the random access procedure (step S312). At this time, the communication control unit 534 is connected to the non-ground station 30 on the basis of the determination in step S311. For example, the communication control unit 534 is connected to the non-ground station 30 by using the resource determined in step S311. After the connection, the acquisition unit 531 of the terminal device 50 performs processing related to update of weather forecast information (step S313).

Subsequently, the discrimination unit 532 of the terminal device 50 discriminates whether or not the weather forecast information has been updated (step S314). If the weather forecast information has been updated (step S314: Yes), the control unit 53 executes the processing of steps S307 to S310 described above.

That is, if the weather forecast information has been updated, the acquisition unit 531 of the terminal device 50 acquires the weather information on the basis of the updated weather forecast information (step S307). Then, the control unit 53 of the terminal device 50 makes a determination related to wireless communication with the non-ground station 30 again on the basis of the new weather information (steps S308 and S309). If a determination that the current connection with the non-ground station 30 needs to be changed (for example, a determination different from the previous determination) is made, the communication control unit 534 of the terminal device 50 performs reconnection to the non-ground station 30 on the basis of the determination.

According to the third embodiment, since the terminal device 50 determines a resource to be used for the wireless communication on the basis of the updated latest weather forecast information, the resource more suitable for the weather can be determined as the resource to be used for the wireless communication. As a result, the terminal device 50 can achieve high communication performance.

### 4. Modification

The above-described embodiments are examples, and various modifications and applications are possible.

### 4-1. Modification Related to Determination of Resource

In the above-described embodiments (the first to third embodiments), the determination unit 533 of the terminal device 50 has determined the resource of the frequency band satisfying the predetermined criterion as the resource used for the wireless communication between the terminal device 50 and the non-ground station 30. For example, in a case where the weather information indicates a predetermined state, the determination unit 533 has determined a resource of the lowest frequency band among a plurality of resources as a resource to be used for wireless communication between the terminal device 50 and the non-ground station 30. Alternatively, in a case where the weather information indicates a predetermined state, the determination unit 533 has determined a resource of a frequency band lower than a predetermined value as a resource to be used for the wireless communication. However, the determination related to the resource by the determination unit 533 is not limited thereto.

For example, in a case where the weather information indicates a predetermined state, the determination unit 533 of the terminal device 50 may determine not to include a frequency band higher than a predetermined criterion in the UE capability (for example, UE capability related to an available frequency band) to be reported to the base station (the non-ground station 30). Then, the communication control unit 534 of the terminal device 50 may report the UE capability (that is, UE capability indicating that only a frequency band lower than a predetermined reference can be used.) indicating that the frequency band higher than the predetermined criterion cannot be used to the base station (the non-ground station 30). This also enables the terminal device 50 to use a resource suitable for the weather for wireless communication.

In addition, the determination related to the resource used by the terminal device 50 is not limited to the determination at the time of connection. For example, in a case where the weather information indicates a predetermined state, the determination unit 533 of the terminal device 50 may determine to stop using a frequency band not satisfying a predetermined criterion among frequency bands currently used for wireless communication. For example, in a case where the weather information indicates a predetermined state, the determination unit 533 may determine to stop using a frequency band higher than a predetermined criterion among frequency bands currently used for wireless communication. This also enables the terminal device 50 to use a resource suitable for the weather for wireless communication.

In addition, the determination related to the resource used by the terminal device 50 is not limited to the determination related to the frequency band. For example, in a case where the weather information indicates a predetermined state, the determination unit 533 of the terminal device 50 may determine a resource having a bandwidth satisfying a predetermined criterion as a resource to be used for wireless communication. For example, in a case where the weather information indicates a predetermined state, the determination unit 533 may determine a resource having the widest bandwidth among a plurality of resources having different bandwidths as a resource to be used for wireless communication. Alternatively, in a case where the weather information indicates a predetermined state, the determination unit 533 may determine a resource having a bandwidth wider than a predetermined width among the plurality of resources as a resource to be used for wireless communication. This also enables the terminal device 50 to use a resource suitable for the weather for wireless communication.

Note that, in determining a resource to be used for the wireless communication, the determination unit 533 may bundle a plurality of channels by dual connectivity, carrier aggregation, or the like to set the plurality of resources as one resource having a bandwidth satisfying a predetermined criterion. In addition, in a case where the weather information indicates a predetermined state, the determination unit 533 may perform wireless communication using the plurality of channels.

### 4-2. Modification Related to Connection Destination

In the above-described embodiments (the first to third embodiments), the determination unit 533 of the terminal device 50 has made a determination related to the used resource as the determination related to wireless communication in the case where the weather information indicates the predetermined state. However, the determination related to wireless communication by the determination unit 533 is not limited thereto. For example, the determination related to wireless communication may include a determination related to a base station serving as a connection destination. For example, the determination related to wireless communication may include a determination related to a non-ground station serving as a connection destination.

### (A) First Modification

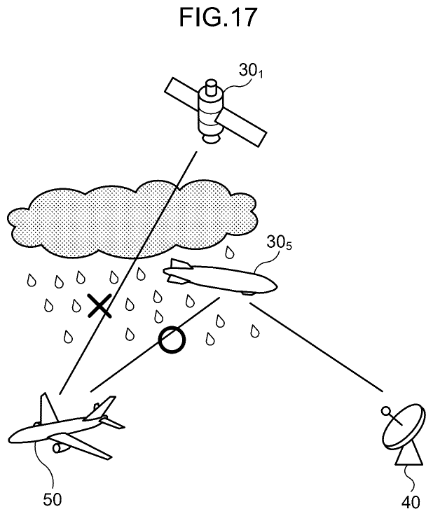

The terminal device 50 may determine the non-ground station 30 located nearby as a non-ground station to be connected. FIG. 17 is a diagram for describing a modification of a determination related to wireless communication. For example, in a case where the weather information indicates a predetermined state, the determination unit 533 of the terminal device 50 may determine the non-ground station 30 having the shortest distance from the terminal device 50 among the plurality of non-ground stations 30 as the non-ground station to be connected. The determination unit 533 may calculate the distance between the terminal device 50 and the non-ground station 30 from a timing advance value. In the example of FIG. 17, the terminal device 50 determines, as the non-ground station to be connected, the non-ground station 305 (aircraft station) having a shorter distance from the terminal device 50 than the non-ground station 301 (satellite station) having a long distance from the terminal device 50. As a result, since the distance at which attenuation occurs is shortened, the terminal device 50 can realize wireless communication with high communication performance.

The communication system 1 according to the present modification may include a communication platform including only an aircraft station such as the HAPS. At this time, the non-ground station 30 (flight vehicle) operated at low altitude of about 2000 m under the rain cloud may provide a communication service (for example, spot communication area providing service) to the terminal device 50. Then, in a case where the weather information indicates a predetermined state, the determination unit 533 of the terminal device 50 may determine the non-ground station 30 having the shortest distance from the terminal device 50 among the plurality of non-ground stations 30 (flight vehicles) located in a predetermined range from the terminal device 50 as the non-ground station to be connected.

### (B) Second Modification

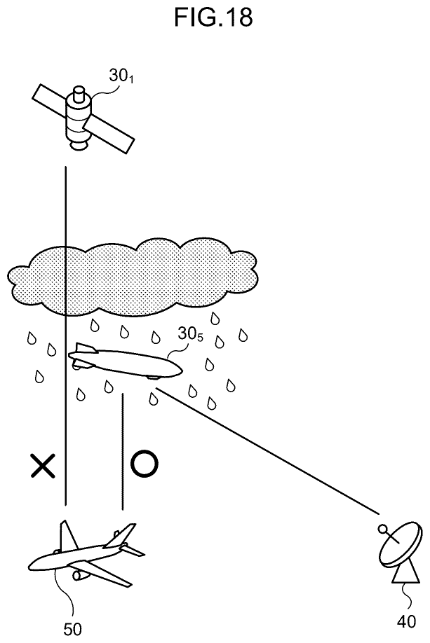

The terminal device 50 may determine the non-ground station 30 having low altitude as the non-ground station to be connected. FIG. 18 is a diagram for describing a modification of a determination related to wireless communication. For example, in a case where the weather information indicates a predetermined state, the determination unit 533 of the terminal device 50 may determine the non-ground station 30 having the lowest altitude among the plurality of non-ground stations 30 as the non-ground station to be connected. The determination unit 533 may estimate the altitude of the non-ground station 30 from the timing advance value. In the example of FIG. 18, the terminal device 50 determines the non-ground station 305 (aircraft station) having a lower altitude than the non-ground station 301 (satellite station) having high altitude as the non-ground station to be connected. As a result, since the distance at which attenuation occurs is shortened, the terminal device 50 can realize wireless communication with high communication performance.

The communication system 1 according to the present modification may include a communication platform including only an aircraft station such as the HAPS. At this time, the non-ground station 30 (flight vehicle) operated at low altitude of about 2000 m under the rain cloud may provide a communication service (for example, spot communication area providing service) to the terminal device 50. Then, in a case where the weather information indicates a predetermined state, the determination unit 533 of the terminal device 50 may determine the non-ground station 30 having the lowest altitude among the plurality of non-ground stations 30 (flight vehicles) located in a predetermined range from the terminal device 50 as the non-ground station to be connected.

### (C) Third Modification

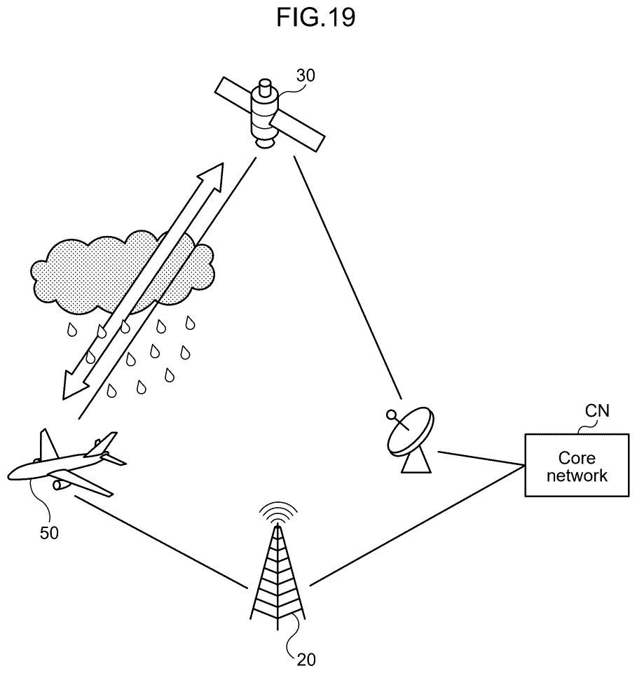

The terminal device 50 may be connected to not only the non-ground station 30 but also the ground station 20 to improve the communication quality. FIG. 19 is a diagram for describing a modification of a determination related to wireless communication. For example, in a case where the weather information indicates a predetermined state, the determination unit 533 of the terminal device 50 may determine to be connected to the ground station 20 in addition to the non-ground station 30. As a result, since the communication quality is improved, the terminal device 50 can realize wireless communication with high communication performance.

### (D) Fourth Modification

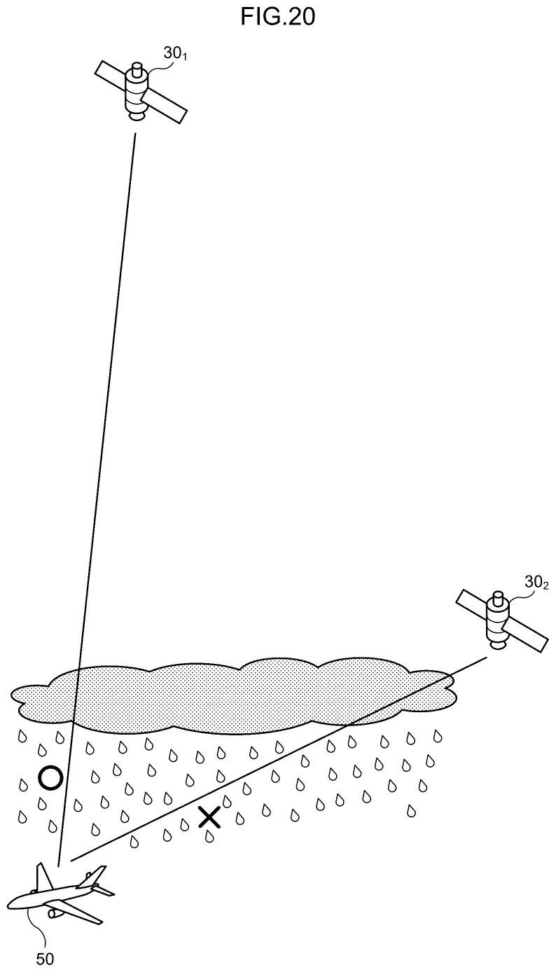

The terminal device 50 may determine the non-ground station 30 having a shorter rain zone as the non-ground station to be connected. FIG. 20 is a diagram for describing a modification of a determination related to wireless communication. For example, the acquisition unit 531 of the terminal device 50 may acquire information (for example, 3D data indicating a weather condition) indicating a range of rain as the weather information. Then, the determination unit 533 of the terminal device 50 may specify the rain zone through which the radio wave connecting the terminal device 50 and the non-ground station 30 is expected to pass on the basis of the position information of the terminal device 50, the position information of the non-ground station 30, and the information indicating the range of rain. Then, the determination unit 533 may determine the non-ground station serving as the connection destination from among the plurality of non-ground stations 30 on the basis of the information on the rain zone. For example, in a case where the rain zone through which the radio wave connecting the terminal device 50 and the non-ground station 301 is expected to pass is shorter than the rain zone through which the radio wave connecting the terminal device 50 and the non-ground station 302 is expected to pass, the non-ground station 301 may be determined as the non-ground station serving as the connection destination. As a result, since the distance at which attenuation occurs is shortened, the terminal device 50 can realize wireless communication with high communication performance.

### (E) Fifth Modification

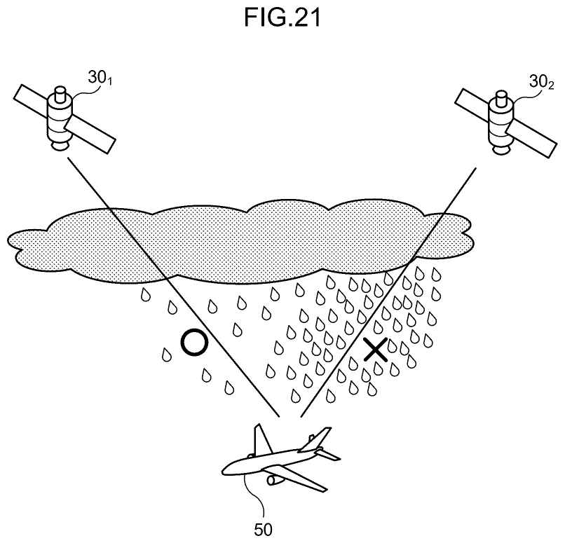

The terminal device 50 may determine the non-ground station 30 having a shorter high-density rain zone as the non-ground station to be connected. FIG. 21 is a diagram for describing a modification of a determination related to wireless communication. For example, the acquisition unit 531 of the terminal device 50 may acquire information (for example, 3D data of weather information including rain density) indicating a range of rain including a rain density as the weather information. Then, the determination unit 533 of the terminal device 50 may specify the rain zone including the density of rain through which the radio wave connecting the terminal device 50 and the non-ground station 30 is expected to pass on the basis of the position information of the terminal device 50, the position information of the non-ground station 30, and the information indicating the range of rain including the density of rain. Then, the determination unit 533 may determine the non-ground station serving as the connection destination from among the plurality of non-ground stations 30 on the basis of the information on the rain zone including the density of rain. For example, in a case where the density of rain included in the rain zone through which the radio wave connecting the terminal device 50 and the non-ground station 301 is expected to pass is lower than the density of rain included in the rain zone through which the radio wave connecting the terminal device 50 and the non-ground station 302 is expected to pass, the non-ground station 301 may be determined as the non-ground station serving as the connection destination.

As a result, since the distance at which attenuation occurs is shortened, the terminal device 50 can realize wireless communication with high communication performance.

### (F) Sixth Modification

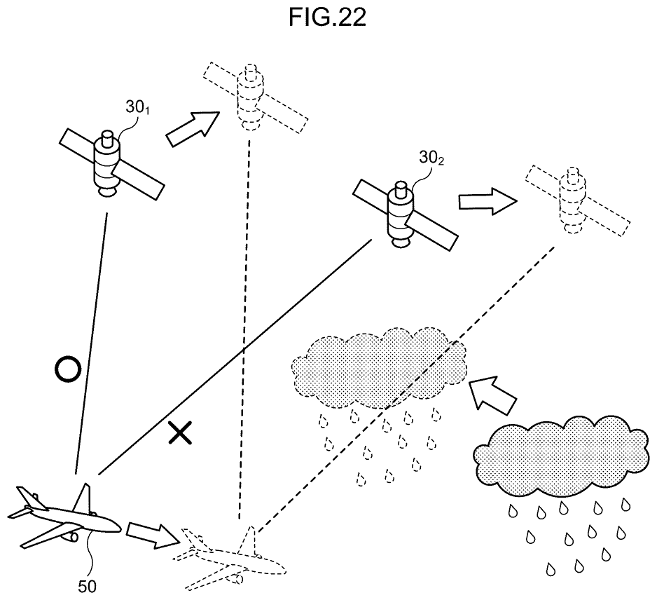

The terminal device 50 may estimate a movement route of weather and determine the non-ground station 30 assumed not to pass through a bad weather section in the future as the non-ground station to be connected. FIG. 22 is a diagram for describing a modification of a determination related to wireless communication. For example, the acquisition unit 531 of the terminal device 50 may acquire information on a movement route of weather as the weather information. In addition to the information on the movement route of weather, the acquisition unit 531 may acquire information on the movement route of the terminal device 50 and information on the movement route of the non-ground station 30. Then, the determination unit 533 of the terminal device 50 may determine the non-ground station serving as the connection destination from among the plurality of non-ground stations 30 on the basis of the information on the movement route of the terminal device 50, the information on the movement route of the non-ground station 30, and the information on the movement route of weather. For example, when the section through which the radio wave connecting the terminal device 50 and the non-ground station 302 is expected to pass at the time when the predetermined time has elapsed is in a predetermined state (for example, rain), and the section through which the radio wave connecting the terminal device 50 and the non-ground station 301 is expected to pass at the time when the predetermined time has elapsed is not in a predetermined state (for example, rain), the non-ground station 301 may be determined as the non-ground station serving as the connection destination.

### 4-3. Modification Related to Consideration Information

In the above-described embodiments (the first to third embodiments), weather information is used as consideration information when the terminal device 50 makes a determination related to wireless communication. However, the consideration information is not limited to the weather information. The following (1) to (5) are assumed as the consideration information.

### (1) Temperature

The terminal device 50 may acquire temperature information of the terminal device 50 (alternatively, the wireless communication unit 51 included in the terminal device 50) as the consideration information. The terminal device 50 may acquire temperature information on the basis of information from the sensor unit 54 (for example, a temperature sensor). Then, the terminal device 50 makes a determination related to wireless communication with the non-ground station 30 on the basis of the temperature information. For example, in a case where the temperature of the terminal device 50 (alternatively, the wireless communication unit 51 included in the terminal device 50) is higher than a predetermined temperature, the terminal device 50 may determine the resource of the frequency band satisfying a predetermined criterion as the resource to be used for wireless communication with the non-ground station 30. In a case where the terminal device 50 moves for a long time, heat becomes a problem. Since a high frequency generally uses power, the terminal device 50 may use a low frequency for wireless communication when the temperature is high. Note that the determination related to wireless communication may include a determination related to a base station serving as the connection destination.

### (2) Battery Remaining Amount

The terminal device 50 may acquire the battery remaining amount information of the terminal device 50 as the consideration information. At this time, the terminal device 50 may acquire the battery remaining amount information on the basis of information from the sensor unit 54 (for example, a voltmeter for measuring voltage of a battery). Then, the terminal device 50 makes a determination related to wireless communication with the non-ground station 30 on the basis of the battery remaining amount information. For example, in a case where the remaining amount of the terminal device 50 is less than a predetermined amount, the terminal device 50 may determine the resource of the frequency band satisfying a predetermined criterion as the resource to be used for wireless communication with the non-ground station 30. In a case where the terminal device 50 is a flying mobile body such as a drone, the battery remaining amount is extremely heavy. Since a high frequency generally uses power, the terminal device 50 may use a low frequency for wireless communication when the battery remaining amount is small. Note that the determination related to wireless communication may include a determination related to a base station serving as the connection destination.

### (3) Position and/or Direction

The terminal device 50 may acquire information on the position and/or direction of the terminal device 50 as the consideration information. At this time, the terminal device 50 may acquire information on the position and/or direction of the terminal device 50 on the basis of information from the sensor unit 54 (for example, an acceleration sensor or a gyro sensor). Then, the terminal device 50 makes a determination related to wireless communication with the non-ground station 30 on the basis of the information on the position and/or direction of the terminal device 50. For example, in a case where the variation in the position and/or direction of the terminal device 50 is larger than a predetermined criterion (that is, in a case where it is assumed that the terminal device 50 is in an unstable state due to strong wind.), the terminal device 50 may determine the resource of the frequency band satisfying a predetermined criterion as the resource to be used for wireless communication with the non-ground station 30. Since it is difficult to control a beam in a high frequency band, the terminal device 50 may use a low frequency for wireless communication when it is assumed that the terminal device 50 is in an unstable state. Note that the determination related to wireless communication may include a determination related to a base station serving as the connection destination.

### (4) Distance to Non-ground Station 30

The terminal device 50 may acquire distance information to the non-ground station 30 (for example, the satellite station) as the consideration information. At this time, the terminal device 50 may acquire the distance information on the basis of the timing advance value. Then, the terminal device 50 makes a determination related to wireless communication with the non-ground station 30 on the basis of the distance information. For example, in a case where the distance to the non-ground station 30 (for example, the satellite station) is longer than a predetermined distance, the terminal device 50 may determine the resource of the frequency band satisfying a predetermined criterion as the resource to be used for wireless communication with the non-ground station 30. Since a radio wave is less likely to reach far as the frequency is higher, in a case where the non-ground station 30 (for example, the satellite station) is far, the terminal device 50 may use a low frequency for wireless communication, for example, from the viewpoint of power consumption. Note that the determination related to wireless communication may include a determination related to a base station serving as the connection destination.

### (5) Obstacle in the Sky

The terminal device 50 may acquire information regarding an obstacle in the sky as the consideration information. At this time, the terminal device 50 may estimate information regarding an obstacle in the sky (for example, information regarding a view in the sky) on the basis of the information on the number of satellites visible from the terminal device 50. The terminal device 50 may acquire information on the number of satellites on the basis of information from the sensor unit 54 (for example, the GNSS sensor). Then, the terminal device 50 may make a determination related to wireless communication with the non-ground station 30 on the basis of the information regarding an obstacle in the sky. For example, in a case where a view in the sky is worse than a predetermined criterion, the terminal device 50 may determine the resource of the frequency band satisfying a predetermined criterion as the resource to be used for wireless communication with the non-ground station 30. For example, in a case where visibility in the sky is poor, such as a case where a vehicle having a communication function with a non-ground station enters a forest or a case where a drone is flying in a high-rise building area, it is difficult for the terminal device 50 to maintain communication with the non-ground station 30 (for example, the satellite station). Therefore, in a case where it is determined that a view in the sky is poor, the terminal device 50 may use, for wireless communication, a low frequency that is more likely to sneak around than a high frequency that linearly advances. Note that the determination related to wireless communication may include a determination related to a base station serving as the connection destination.

### 4-4. Other Modifications

In the above-described embodiments (the first to third embodiments), the device that makes a determination related to wireless communication is the terminal device 50, but the device that makes a determination related to wireless communication is not limited to the terminal device 50. The device that makes a determination related to wireless communication may be the non-ground station 30. In this case, the descriptions of the terminal device 50, the acquisition unit 531, the discrimination unit 532, the determination unit 533, and the communication control unit 534 that appear in the above-described embodiments can be replaced with the non-ground station 30, the acquisition unit 331, the discrimination unit 332, the determination unit 333, or the communication control unit 334. In addition, the device that makes a determination related to wireless communication may be the management device 10, the ground station 20, or the relay station 40.

The control device that controls the management device 10, the ground station 20, the non-ground station 30, the relay station 40, and the terminal device 50 of the present embodiment may be realized by a dedicated computer system or a general-purpose computer system.

For example, a communication program for executing the above-described operations is stored in a computer-readable recording medium such as an optical disk, a semiconductor memory, a magnetic tape, or a flexible disk and distributed. Then, for example, the program is installed in a computer, and the above-described processing is executed to configure the control device. At this time, the control device may be a device (for example, a personal computer) outside the management device 10, the ground station 20, the non-ground station 30, the relay station 40, or the terminal device 50. In addition, the control device may be a device (for example, the control unit 13, the control unit 23, the control unit 33, the control unit 43, or the control unit 53) inside the management device 10, the ground station 20, the non-ground station 30, the relay station 40, or the terminal device 50.

In addition, the communication program may be stored in a disk device included in a server device on a network such as the Internet so that the communication program can be downloaded to a computer. In addition, the above-described functions may be realized by cooperation between an operating system (OS) and application software. In this case, a portion other than the OS may be stored in a medium and distributed, or the portion other than the OS may be stored in the server device and downloaded to the computer.

Among the processing described in the above embodiments, all or a part of the processing described as being performed automatically can be performed manually, or all or a part of the processing described as being performed manually can be performed automatically by a known method. In addition, the processing procedure, specific name, and information including various data and parameters illustrated in the documents and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments can be appropriately combined in a region in which the processing contents do not contradict each other. In addition, the order of each step illustrated in the flowcharts or the sequence diagrams of the above-described embodiments can be changed as appropriate.

In addition, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to the unit, or the like (that is, a configuration of a part of the device).

Note that, in the present embodiment, the system means aggregation of a plurality of components (devices, modules (parts), etc.), and it does not matter whether all the components are in the same housing. Therefore, a plurality of devices housed in separate housings and connected to each other via a network and one device in which a plurality of modules is housed in one housing are both systems.

In addition, for example, the present embodiment can adopt a configuration of cloud computing in which one function is shared and processed by a plurality of devices in cooperation via a network.

### 5. Conclusion

As described above, the terminal device 50 of the present embodiment makes a determination related to wireless communication with the non-ground station 30 on the basis of the weather information. For example, in a case where the weather information indicates a predetermined state (for example, rain), the terminal device 50 determines a wireless resource of a frequency satisfying a predetermined criterion as a resource to be used for wireless communication. For example, in a case where the current weather near the terminal device is rain, the terminal device determines the wireless resource of a frequency band lower than a predetermined value as the resource to be used for wireless communication.

As a result, the terminal device 50 can be connected to the non-ground station 30 by a communication method suitable for the weather at the time when communication is performed. For example, in the case of rain, the terminal device 50 can be connected to the non-ground station 30 by using the resource of a low frequency band. Therefore, the terminal device 50 can enhance the stability of the connection with the non-ground station 30 regardless of the weather. As a result, the terminal device 50 can achieve high communication performance even in communication using the non-terrestrial network.

In addition, the effects of each embodiment described in the present specification are merely examples and are not limited, and other effects may be provided.

Note that the present technology can also have the following configurations.

(1)

A terminal device functioning as a mobile station that performs wireless communication with at least one of one or more non-ground stations, the terminal device comprising:
an acquisition unit that acquires weather information;
a determination unit that makes a determination related to the wireless communication on a basis of the weather information.
   (2)

The terminal device according to (1), comprising
one or more sensors capable of performing measurement related to weather,
wherein the acquisition unit acquires the weather information on a basis of information from the one or more sensors.
   (3)

The terminal device according to (2),
wherein the one or more sensors include at least one of a rain-sensitive sensor, a humidity sensor, and a temperature sensor.
   (4)

The terminal device according to (1), comprising
a storage unit that stores weather forecast information,
wherein the acquisition unit acquires the weather information on a basis of the weather forecast information stored in the storage unit.
   (5)

The terminal device according to (4), comprising
a communication control unit that is connected to at least one of the one or more non-ground stations on a basis of the determination related to the wireless communication.
   (6)

The terminal device according to (5),
wherein the acquisition unit, after being connected to at least one of the one or more non-ground stations, performs processing related to update of the weather forecast information via the wireless communication,
in a case where the weather forecast information is updated, the determination unit makes the determination related to the wireless communication again on a basis of the weather information acquired on a basis of the updated weather forecast information, and
in a case where it is determined that a current connection with the non-ground station needs to be changed, the communication control unit performs reconnection to at least one of the one or more non-ground stations on a basis of the determination related to the wireless communication again.
   (7)

The terminal device according to (5),
wherein in a case where an age of the weather forecast information stored in the storage unit satisfies a predetermined criterion, the communication control unit is connected to at least one of the one or more non-ground stations on a basis of a predetermined setting before the determination related to the wireless communication,
the acquisition unit updates the weather forecast information via the wireless communication after the connection on a basis of the predetermined setting,
the determination unit makes a determination related to the wireless communication on a basis of the weather information acquired on a basis of the updated weather forecast information, and
in a case where it is determined that setting of current connection with the non-ground station needs to be changed from the predetermined setting, the communication control unit performs reconnection to at least one of the one or more non-ground stations on a basis of the determination related to the wireless communication.
   (8)

The terminal device according to any one of (1) to (7),
wherein in a case where the weather information indicates a predetermined state, the determination unit determines a wireless resource of a frequency band satisfying a predetermined criterion as a resource to be used for the wireless communication.
   (9)

The terminal device according to (8),
wherein in a case where the weather information indicates a predetermined state, the determination unit determines a wireless resource of a lowest frequency band among a plurality of wireless resources as the resource to be used for the wireless communication.
   (10)

The terminal device according to (8),
wherein in a case where the weather information indicates a predetermined state, the determination unit determines a wireless resource of a frequency band lower than a predetermined value as the resource to be used for the wireless communication.
   (11)

The terminal device according to (8),
wherein in a case where the weather information indicates a predetermined state, the determining unit determines not to include a frequency band not satisfying a predetermined criterion in UE capability related to an available frequency band to be reported to a base station.
   (12)

The terminal device according to (8),
wherein in a case where the weather information indicates a predetermined state, the determination unit determines to stop using a frequency band not satisfying the predetermined criterion among frequency bands currently used for the wireless communication.
   (13)

The terminal device according to any one of (1) to (12),
wherein the determination related to the wireless communication includes at least a determination related to the non-ground station serving as a connection destination.
   (14)

The terminal device according to (13),
wherein in a case where the weather information indicates a predetermined state, the determination unit determines, as the non-ground station serving as a connection destination, a non-ground station having a shortest distance or a non-ground station having a lowest altitude among the plurality of non-ground stations.
   (15)

The terminal device according to (13),
wherein the weather information includes information indicating a range of rain, and
the determination unit determines the non-ground station serving as a connection destination from among the plurality of non-ground stations on a basis of information on a rain zone through which a radio wave is expected to pass, the information being specified on a basis of position information of the terminal device, position information of the non-ground station, and information indicating the range of rain.
   (16)

The terminal device according to (13),
wherein the weather information includes information indicating a range of rain including a density of rain, and
the determination unit determines the non-ground station serving as a connection destination from among the plurality of non-ground stations on a basis of information on a rain zone through which a radio wave is expected to pass, the rain zone being specified on a basis of position information of the terminal device, position information of the non-ground station, and information indicating a range of rain including the density of rain.
   (17)

The terminal device according to (13),
wherein the weather information includes information on a movement route of weather, and
the determination unit determines the non-ground station serving as a connection destination from among the plurality of non-ground stations on a basis of information on a movement route of the terminal device, information on a movement route of the non-ground station, and information on a movement route of the weather.
   (18)

The terminal device according to any one of (1) to (17),
wherein in a case where the weather information indicates a predetermined state, the determination unit determines to be connected to a ground station in addition to the non-ground station.
   (19)

The terminal device according to any one of (1) to (18),
wherein in a case where the weather information indicates a predetermined state, the determination unit determines a wireless resource having a bandwidth satisfying a predetermined criterion as the resource to be used for the wireless communication.
   (20)

A communication method executed by a terminal device functioning as a mobile station that performs wireless communication with at least one of one or more non-ground stations, the communication method comprising:
acquiring weather information; and
making a determination related to the wireless communication on a basis of the weather information.

### REFERENCE SIGNS LIST

1 COMMUNICATION SYSTEM
10 MANAGEMENT DEVICE
20 GROUND STATION
30 NON-GROUND STATION
40 RELAY STATION
50 TERMINAL DEVICE
11 COMMUNICATION UNIT
21, 31, 41, 51 WIRELESS COMMUNICATION UNIT
12, 22, 32, 42, 52 STORAGE UNIT
13, 23, 33, 43, 53 CONTROL UNIT
24, 44 NETWORK COMMUNICATION UNIT
34, 54 SENSOR UNIT
211, 311, 411, 511 RECEPTION PROCESSING UNIT
212, 312, 412, 512 TRANSMISSION PROCESSING UNIT
213, 313, 413, 513 ANTENNA
331, 531 ACQUISITION UNIT
332, 532 DISCRIMINATION UNIT
333, 533 DETERMINATION UNIT
334, 534 COMMUNICATION CONTROL UNIT

1. A terminal device functioning as a mobile station that performs wireless communication with at least one of one or more non-ground stations, the terminal device comprising:
an acquisition unit that acquires weather information; and
a determination unit that makes a determination related to the wireless communication on a basis of the weather information.

2. The terminal device according to claim 1, comprising
one or more sensors capable of performing measurement related to weather,
wherein the acquisition unit acquires the weather information on a basis of information from the one or more sensors.

3. The terminal device according to claim 2,
wherein the one or more sensors include at least one of a rain-sensitive sensor, a humidity sensor, and a temperature sensor.

4. The terminal device according to claim 1, comprising
a storage unit that stores weather forecast information,
wherein the acquisition unit acquires the weather information on a basis of the weather forecast information stored in the storage unit.

5. The terminal device according to claim 4, comprising
a communication control unit that is connected to at least one of the one or more non-ground stations on a basis of the determination related to the wireless communication.

6. The terminal device according to claim 5,
wherein the acquisition unit, after being connected to at least one of the one or more non-ground stations, performs processing related to update of the weather forecast information via the wireless communication,
in a case where the weather forecast information is updated, the determination unit makes the determination related to the wireless communication again on a basis of the weather information acquired on a basis of the updated weather forecast information, and
in a case where it is determined that a current connection with the non-ground station needs to be changed, the communication control unit performs reconnection to at least one of the one or more non-ground stations on a basis of the determination related to the wireless communication again.

7. The terminal device according to claim 5,
wherein in a case where an age of the weather forecast information stored in the storage unit satisfies a predetermined criterion, the communication control unit is connected to at least one of the one or more non-ground stations on a basis of a predetermined setting before the determination related to the wireless communication,
the acquisition unit updates the weather forecast information via the wireless communication after the connection on a basis of the predetermined setting, the determination unit makes a determination related to the wireless communication on a basis of the weather information acquired on a basis of the updated weather forecast information, and
in a case where it is determined that setting of current connection with the non-ground station needs to be changed from the predetermined setting, the communication control unit performs reconnection to at least one of the one or more non-ground stations on a basis of the determination related to the wireless communication.

8. The terminal device according to claim 1,
wherein in a case where the weather information indicates a predetermined state, the determination unit determines a wireless resource of a frequency band satisfying a predetermined criterion as a resource to be used for the wireless communication.

9. The terminal device according to claim 8,
wherein in a case where the weather information indicates a predetermined state, the determination unit determines a wireless resource of a lowest frequency band among a plurality of wireless resources as the resource to be used for the wireless communication.

10. The terminal device according to claim 8,
wherein in a case where the weather information indicates a predetermined state, the determination unit determines a wireless resource of a frequency band lower than a predetermined value as the resource to be used for the wireless communication.

11. The terminal device according to claim 8,
wherein in a case where the weather information indicates a predetermined state, the determining unit determines not to include a frequency band not satisfying a predetermined criterion in UE capability related to an available frequency band to be reported to a base station.

12. The terminal device according to claim 8,
wherein in a case where the weather information indicates a predetermined state, the determination unit determines to stop using a frequency band not satisfying the predetermined criterion among frequency bands currently used for the wireless communication.

13. The terminal device according to claim 1,
wherein the determination related to the wireless communication includes at least a determination related to the non-ground station serving as a connection destination.

14. The terminal device according to claim 13,
wherein in a case where the weather information indicates a predetermined state, the determination unit determines, as the non-ground station serving as a connection destination, a non-ground station having a shortest distance or a non-ground station having a lowest altitude among the plurality of non-ground stations.

15. The terminal device according to claim 13,
wherein the weather information includes information indicating a range of rain, and
the determination unit determines the non-ground station serving as a connection destination from among the plurality of non-ground stations on a basis of information on a rain zone through which a radio wave is expected to pass, the information being specified on a basis of position information of the terminal device, position information of the non-ground station, and information indicating the range of rain.

16. The terminal device according to claim 13,
wherein the weather information includes information indicating a range of rain including a density of rain, and
the determination unit determines the non-ground station serving as a connection destination from among the plurality of non-ground stations on a basis of information on a rain zone through which a radio wave is expected to pass, the rain zone being specified on a basis of position information of the terminal device, position information of the non-ground station, and information indicating a range of rain including the density of rain.

17. The terminal device according to claim 13,
wherein the weather information includes information on a movement route of weather, and
the determination unit determines the non-ground station serving as a connection destination from among the plurality of non-ground stations on a basis of information on a movement route of the terminal device, information on a movement route of the non-ground station, and information on a movement route of the weather.

18. The terminal device according to claim 1,
wherein in a case where the weather information indicates a predetermined state, the determination unit determines to be connected to a ground station in addition to the non-ground station.

19. The terminal device according to claim 1,
wherein in a case where the weather information indicates a predetermined state, the determination unit determines a wireless resource having a bandwidth satisfying a predetermined criterion as the resource to be used for the wireless communication.

20. A communication method executed by a terminal device functioning as a mobile station that performs wireless communication with at least one of one or more non-ground stations, the communication method comprising:
acquiring weather information; and
making a determination related to the wireless communication on a basis of the weather information.
